(19) United States
(12) Patent Application Publication
(10) Pub. No.: US 2025/0062374 A1
(43) Pub. Date: Feb. 20, 2025

(54) VEHICLE WITH FUEL CELL CONTROL SYSTEM AND MODES OF OPERATION

(71) Applicant: Oshkosh Defense, LLC, Oshkosh, WI (US)

(72) Inventor: Christopher Archambo, Oshkosh, WI (US)

(73) Assignee: Oshkosh Defense, LLC, Oshkosh, WI (US)

(21) Appl. No.: 18/802,748

(22) Filed: Aug. 13, 2024

Related U.S. Application Data
(60) Provisional application No. 63/532,585, filed on Aug. 14, 2023.

(51) Int. Cl. H01M 8/04694; B60L 50/75; B60L 58/32; H01M 8/04014; H01M 8/04313; H01M 8/0432; H01M 8/04492; H01M 8/04701; H01M 10/44; H01M 16/00

(52) U.S. Cl. CPC H01M 8/04694; B60L 50/75; B60L 58/32; H01M 8/04014; H01M 8/04313; H01M 8/0432; H01M 8/04492; H01M 8/04701; H01M 10/44; H01M 16/006; H01M 2220/20; H01M 2250/20

(57) ABSTRACT

A vehicle includes an electric motor, a fuel cell, and a fuel cell thermal management system. A control system of the vehicle is configured to operate the fuel cell and the fuel cell thermal management system according to different modes. The modes include an acoustic signature mode in which an acoustic signature of the vehicle is reduced, a thermal signature mode in which a thermal signature of the vehicle is reduced, an acoustic and thermal signature mode in which both the acoustic signature and the thermal signature of the vehicle are reduced, a mission mode in which the vehicle is a node of a mesh network of other vehicles, and an optimized efficiency mode in which the fuel cell and the fuel cell thermal management system are controlled based on ambient conditions.

### CROSS-REFERENCE TO RELATED PATENT APPLICATION

This application claims the benefit of and priority to U.S. Provisional Application No. 63/532,585, filed Aug. 14, 2023, the entire disclosure of which is incorporated by reference herein.

### BACKGROUND

The present disclosure relates to a fuel cell. More specifically, the present disclosure relates to a control system for a fuel cell.

### SUMMARY

One embodiment of the present disclosure relates to a vehicle. The vehicle includes a battery, an electric motor, a fuel cell, a fuel cell thermal management system (TMS), and a controller. The battery is configured to supply energy to multiple loads. The electric motor is configured to receive energy from the battery. The fuel cell is configured to operate to provide energy to the battery. The fuel cell TMS includes a fan, a coolant pump, and a radiator. The fuel cell TMS is configured to provide cooling to the fuel cell. The controller includes processing circuitry. The processing circuitry is configured to operate the fuel cell and the fuel cell TMS according to an acoustic signature control mode in which an acoustic signature of the vehicle is reduced. The processing circuitry is also configured to operate the fuel cell and the fuel cell TMS according to a thermal signature control mode in which a thermal signature of the vehicle is reduced. The processing circuitry is also configured to operate the fuel cell and the fuel cell TMS according to an acoustic and thermal signature control mode in which both the acoustic signature and the thermal signature of the vehicle are reduced. The processing circuitry is also configured to operate the fuel cell and the fuel cell TMS according to an optimized efficiency mode in which the controller adjusts operation based on ambient conditions to reduce energy losses of the fuel cell, the fuel cell TMS, and the battery. The processing circuitry is also configured to operate the fuel cell and the fuel cell TMS according to a mission mode in which the controller automatically transitions between at least the acoustic signature control mode, the thermal signature control mode, the acoustic and thermal signature control mode, and the optimized efficiency mode based on mission data obtained from a mesh network of vehicles.

Another embodiment of the present disclosure is a system for a vehicle. The system includes a fuel cell, a fuel cell thermal management system (TMS) configured to provide heating or cooling to the fuel cell, and processing circuitry. The processing circuitry is configured to operate the fuel cell and the fuel cell TMS such that an acoustic signature or thermal signature of the vehicle is controlled to a target acoustic signature level or a target thermal signature level.

Another embodiment of the present disclosure is a method of controlling a fuel cell system of a vehicle. The method includes obtaining feedback from a sensor of the fuel cell system. The method also includes operating a fuel cell and a fuel cell thermal management system (TMS) based on the feedback according to an acoustic signature control mode in which an acoustic signature of the vehicle is adjusted towards a target acoustic signature level. The method also includes operating the fuel cell and the fuel cell TMS based on the feedback according to a thermal signature control mode in which a thermal signature of the vehicle is adjusted towards a target thermal signature level. The method also includes operating the fuel cell and the fuel cell TMS based on the feedback according to an acoustic and thermal signature control mode in which both the acoustic signature is adjusted towards the target acoustic signature level and the thermal signature of the vehicle is adjusted towards the target thermal signature level. The method also includes operating the fuel cell and the fuel cell TMS based on the feedback according to an optimized efficiency mode in which operation of the fuel cell and the fuel cell TMS is adjusted based on ambient conditions to reduce energy losses of the fuel cell, the fuel cell TMS, and a battery. The method also includes operating the fuel cell and the fuel cell TMS based on the feedback according to a mission mode in which the vehicle is automatically transitioned between at least the acoustic signature control mode, the thermal signature control mode, the acoustic and thermal signature control mode, and the optimized efficiency mode based on mission data obtained from a mesh network of vehicles.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a block diagram of a vehicle including a fuel cell and a fuel cell thermal management system, according to some embodiments.

FIG. 2 is a block diagram of a driveline of the vehicle of FIG. 1, according to some embodiments.

FIG. 3 is a block diagram of a controller for the fuel cell thermal management system of FIG. 1, the controller configured to operate according to different operating modes, according to some embodiments.

FIG. 4 is a diagram of the fuel cell thermal management system of FIG. 1 being operated by the controller in a first mode, according to some embodiments.

FIG. 5 is a block diagram of a sample implementation of the first mode of FIG. 4, according to some embodiments.

FIG. 6 is a flow diagram of a process for operating a fuel cell thermal management system according to the first mode of FIG. 4, according to some embodiments.

FIG. 7 is a block diagram of the fuel cell thermal management system of FIG. 1 being operated in a second mode by the controller, according to some embodiments.

FIG. 8 is a flow diagram of a process for operating a fuel cell thermal management system according to the second mode, according to some embodiments.

FIG. 9 is a block diagram of the fuel cell thermal management system of FIG. 1 being operated in a third mode by the controller, according to some embodiments.

FIG. 10 is a flow diagram of a process for operating a fuel cell thermal management system according to the third mode of FIG. 9, according to some embodiments.

FIG. 11 is a block diagram of multiple vehicles or assets that implement a fourth mode communicatively coupled with each other via a mesh network, according to some embodiments.

FIG. 12A is a map of an area that is used to trigger transitioning between different modes of the vehicles that implement the fourth mode, according to some embodiments.

FIG. 12B is another map of the area of FIG. 12A after detection of a threat, according to some embodiments.

FIG. 13 is a flow diagram of an example process or state diagram of a vehicle implementing the fourth mode, according to some embodiments.

FIG. 14 is a block diagram of the fuel cell thermal management system of FIG. 1 being operated in a fifth mode by the controller, according to some embodiments.

FIG. 15 is a flow diagram of a process for operating a vehicle according to the fifth mode, according to some embodiments.

FIG. 16 is a diagram illustrating the determination of an energy loss to energy out ratio for the fifth mode, according to some embodiments.

FIG. 17 is a flow diagram of a process for controlling a fuel cell, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a hybrid vehicle includes a fuel cell and an electric motor. The fuel cell is configured to operate to produce energy for a battery that may provide energy to the electric motor to transport the vehicle. The fuel cell can be cooled or thermally managed by a thermal management system. The fuel cell, the electric motor, and the thermal management system may be operated by a control system including a controller. The controller is configured to operate the fuel cell, the electric motor, and the thermal management system according to different modes. The modes may include an acoustic signature mode in which the controller operates the fuel cell, the electric motor, and the thermal management system in order to reduce acoustic signature of the vehicle. The modes may also include a thermal signature mode in which the controller operates the fuel cell, the electric motor, and the thermal management system in order to reduce a thermal signature of the vehicle. The modes may also include an acoustic and thermal signature mode in which the controller operates the fuel cell, the electric motor, and the thermal management system to reduce both the acoustic signature and the thermal signature of the vehicle based on acoustic and thermal characteristics of an environment. The modes may also include a mission mode in which the vehicle exchanges data with other vehicles in an area, and based on an assessed threat level, automatically transitions between the different modes. The modes may also include an optimized efficiency mode in which the controller operates the fuel cell, the electric motor, and the thermal management system to improve energy efficiency of the vehicle while still achieving commanded inputs.

### Overall Vehicle

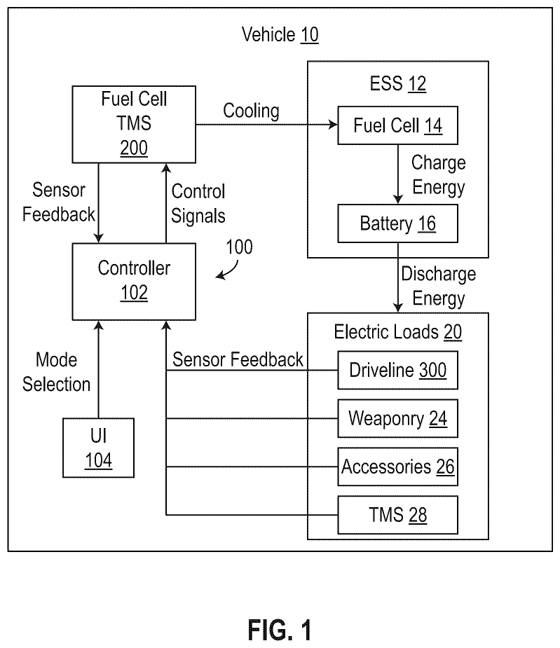

According to the exemplary embodiment shown in FIG. 1, a vehicle 10 (e.g., a heavy duty vehicle, a commercial vehicle, a tank, a military vehicle, a truck, a machine, a boat, a hull, a rotational propulsive system, an electric vehicle, an autonomous vehicle, etc.) includes an energy storage system (ESS) 12, a fuel cell thermal management system (TMS) 200, one or more electric loads 20, and a control system 100. The vehicle 10 may also include a body (e.g., a shell, a cab, a cabin assembly, etc.), a chassis (e.g., a frame, a hull, a carriage, etc.), tractive elements, and a primary mover (e.g., a diesel engine, a gasoline engine, an internal combustion engine, an electric motor, etc.). The primary mover and the body can be supported by (e.g., fixedly coupled with) the chassis. In some embodiments, the primary mover is coupled with the chassis (e.g., secured, fastened, or otherwise attached on the chassis). The primary mover outputs mechanical energy in the form of torque (e.g., by driving a shaft to rotate), which can be transferred through a transmission or a driveline to transport the vehicle 10. In some embodiments, the primary mover is configured to drive the tractive elements to rotate to thereby transport the vehicle along a ground surface. The vehicle can also include a steering system that receives steering input from an operator (e.g., an on-board operator, or a remote operator) and rotates two or more of the tractive elements to indicate a turn. In some embodiments, the chassis, the body, and the primary mover are supported by the tractive elements. If the controller 102 is implemented for a vehicle having an internal combustion engine, the controller 102 may monitor exhaust gas an exhaust gas temperatures in order to reduce thermal and/or acoustic signatures of the vehicle 10 or to perform any of the modes described in greater detail below.

The ESS 12 is configured to provide electrical energy to the one or more electric loads 20 of the vehicle 10. In some embodiments, the ESS 12 includes a fuel cell 14, and one or more batteries, shown as battery 16 (e.g., electrical energy storage devices). The fuel cell 14 is configured to consume fuel and provide electrical energy to the battery 16 (e.g., charge energy) in order to maintain a sufficient charge level at the battery 16. The battery 16 is configured to output electrical energy (e.g., discharge energy) to any of the electric loads. The electric loads 20 can include a variety of electrical components, equipment, etc., including but not limited to a driveline 300, weaponry 24, accessories 26, and a thermal management system (TMS) 28 for occupants of the vehicle 10. In some embodiments, the control system 100 and any components of the control system 100 is also configured to receive electrical energy from the battery 16. The battery 16 can also provide electrical energy to the fuel cell TMS 200. It should be understood that the battery 16 of the ESS 12 may be configured to provide electrical energy for any components of the vehicle 10. The fuel cell 14 may be a hydrogen fuel cell, a methanol fuel cell, a natural gas fuel cell, etc. The vehicle 10 may be an electric or hybrid Light Reconnaissance Vehicle. In some embodiments, the vehicle 10 is a heavy duty vehicle, a tank, a fighting vehicle, etc.

The control system 100 includes a controller 102 and a user interface (UI) 104, according to some embodiments. The controller 102 is configured to receive sensor feedback or measurements from any sensors, devices, or systems of the vehicle 10 such as the driveline 300, the fuel cell TMS 200, the ESS 12 (e.g., from sensors associated with the battery 16 and/or the fuel cell 14), the weaponry 24, the accessories 26, and/or the TMS 28. In some embodiments, the controller 102 is configured to operate the fuel cell TMS 200 according to a variety of different modes. In some embodiments, the controller 102 uses any of the feedback or measurements described herein in order to determine controls for the fuel cell TMS 200 according to an active one of the modes. In some embodiments, the controller 102 is configured to receive a mode selection from the UI 104. The UI 104 may be disposed locally on the vehicle 10 if the vehicle 10 is a manned vehicle, or remotely from the vehicle 10 if the vehicle 10 is an autonomous or remotely controlled vehicle. The mode selection provided by the UI 104 may indicate a desired one of the modes of operation that an operator of the vehicle 10 wishes the controller 102 to operate in accordance with. The UI 104 may include one or more input devices, buttons, a touch screen, a display screen, etc. In some embodiments, the UI 104 is a human machine interface (HMI) configured to both display data associated with the vehicle 10 and to receive the mode selection. The controller 102 can use the mode selection to activate or switch between the different modes. In some embodiments, the controller 102 is configured to automatically switch between the different modes based on feedback, without requiring a user input.

### Driveline

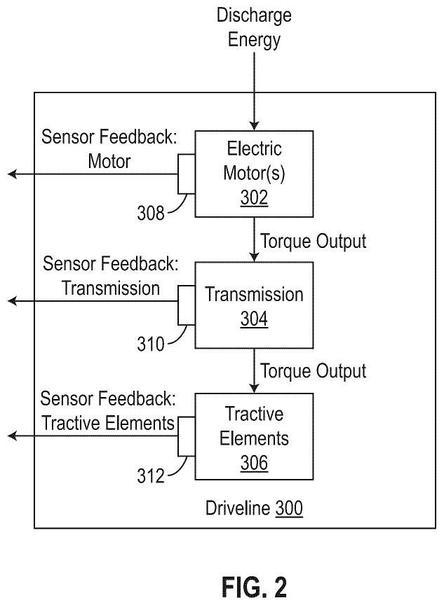

Referring to FIG. 2, the driveline 300 includes one or more electric motors 302, a transmission 304, and tractive elements 306, according to some embodiments. In some embodiments, the electric motors 302 are configured to receive the discharge energy from the battery 16 and use the discharge energy to output a torque to the transmission 304 (e.g., a gearbox, a gearset, etc.). The transmission 304 is configured to receive the torque from the electric motors 302 and transfer or output a torque to the one or more tractive elements 306 in order to drive the tractive elements 306 to transport the vehicle 10. In some embodiments, the electric motors 302 include a sensor 308 configured to obtain sensor feedback of the motor 302 and provide the sensor feedback to the controller 102. In some embodiments, the sensor feedback of the motor 302 includes any of, or any combination of: a motor speed, a torque output, a power consumption, a voltage, etc., of the motor 302. In some embodiments, the transmission 304 includes a transmission sensor 310 that is configured to obtain sensor feedback of the transmission 304 and provide the sensor feedback to the controller 102. In some embodiments, the sensor feedback of the transmission 304 includes any of, or any combination of: transmission speed, current transmission gear, transmission power generation, etc. In some embodiments, the tractive elements 306 include a tractive element sensor 312 configured to obtain sensor feedback of the tractive elements 306 and provide the sensor feedback to the controller 102. The sensor feedback of the tractive elements 306 may include any or, or any combination of, wheel speed, vehicle speed, speed of rotation, speed of tractive elements, tractive element slippage, tire pressure, etc. The controller 102 can use any of the feedback obtained from the sensor 308, the sensor 310, or the sensor 312 in order to generate control signals or control decisions for the fuel cell TMS 200.

### Controller

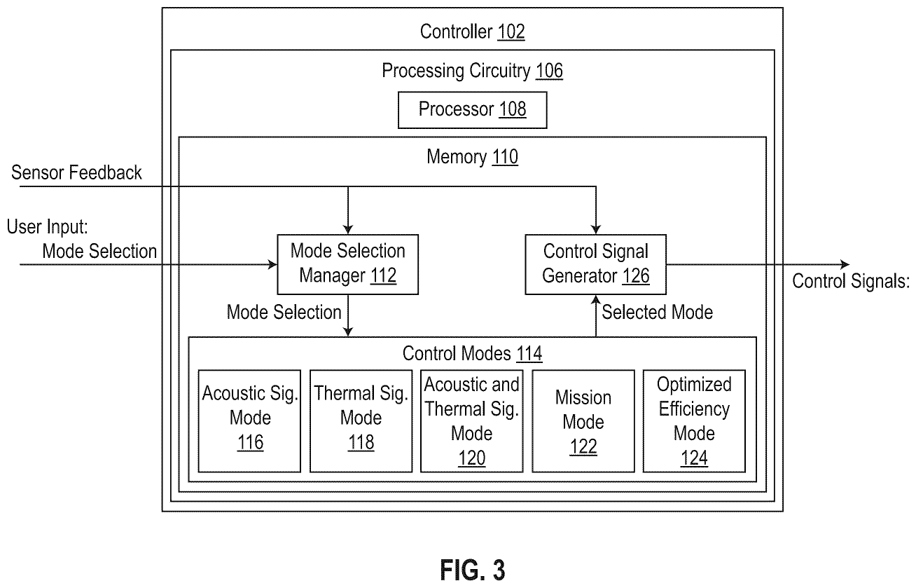

Referring to FIG. 3, the controller 102 is configured to obtain the sensor feedback, or more generally, feedback, a user input (e.g., the mode selection), and generate controls for the fuel cell TMS 200 based on the feedback and a selected or active mode, according to some embodiments. In some embodiments, the controller 102 includes processing circuitry 106, a processor 108, and memory 110. Processing circuitry 106 can be communicably connected to a communications interface such that processing circuitry 106 and the various components thereof can send and receive data via the communications interface. Processor 108 can be implemented as a general purpose processor, an application specific integrated circuit (ASIC), one or more field programmable gate arrays (FPGAs), a group of processing components, or other suitable electronic processing components.

Memory 110 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 110 can be or include volatile memory or non-volatile memory. Memory 110 can include database components, object code components, script components, or any other type of information structure for supporting the various activities and information structures described in the present application. According to some embodiments, memory 110 is communicably connected to processor 108 via processing circuitry 106 and includes computer code for executing (e.g., by processing circuitry 106 and/or processor 108) one or more processes described herein.

In some embodiments, controller 102 is implemented within a single computer (e.g., one server, one housing, etc.). In various other embodiments, the functionality of the controller 102 can be distributed across multiple servers or computers (e.g., that can exist in distributed locations).

Referring still to FIG. 3, the controller 102 includes a mode selection manager 112, a control modes database 114, and a control signal generator 126. The control modes database 114 includes an acoustic signature control mode 116, a thermal signature control mode 118, an acoustic and thermal signature control mode 120, a mission mode 122, and an optimized efficiency mode 124. The control modes database 114 generally stores and provides different settings or modes of operation that, when implemented by the control signal generator 126 (e.g., when activated or switched to), result in the control signal generator 126 generating and providing controls according to an activated or selected one of the modes of the control modes database 114. In some embodiments, the mode selection manager 112 is configured to receive the mode selection from the UI 104 and activate one of the modes of the control modes database 114 such that the control signal generator 126 uses the activated mode. In some embodiments, the mode selection manager 112 is configured to use any of the sensor feedback in order to automatically determine which of the modes of the control modes database 114 should be activated, and to automatically activate one of the modes of the control modes database 114.

The control signal generator 126 is configured to receive any of the sensor feedback as described herein and use the sensor feedback in order to generate controls for one or more components of the vehicle 10 according to an active one of the modes of the control modes database 114. In some embodiments, the control signal generator 126 is configured to generate controls, according to the active mode, based on the sensor feedback for any controllable device of the fuel cell TMS 200 in order to operate the fuel cell TMS 200 according to the active mode.

In the acoustic signature control mode 116, the controller 102 generates controls for the fuel cell TMS 200 in order to prioritize minimization or reduction of acoustic signature of the vehicle 10. In the acoustic signature control mode 116, the acoustic signature of the vehicle 10 may be prioritized over thermal signature and fuel cell power generation. The acoustic signature of the vehicle 10 may include a total or cumulative amount of noise produced by one or more noise-producing components of the fuel cell TMS 200. It should be understood that the acoustic signature of the vehicle 10 may be defined in terms of noises or frequencies that are audible to the human ear, noises or frequencies that are not audible to the human ear, or a combination of noises that are both audible and non-audible to the human ear. The acoustic signature control mode 116 can advantageously be used when the vehicle 10 is expected to be around humans in order to reduce noise produced by the vehicle 10. The acoustic signature mode 116 can be used in missions or applications where thermal signature reduction is not required, but acoustic signature reduction is required in order to improve stealth and concealability of the vehicle 10. In some embodiments, the acoustic signature control mode 116 is also usable in order to improve the experience of an individual nearby the vehicle 10. For example, if the vehicle 10 is particularly noisy, such noise and acoustic signature may make it difficult for individuals conversing with each other near the vehicle 10 to hear each other.

In the thermal signature control mode 118, the controller 102 generates controls for the fuel cell TMS 200 in order to prioritize minimization or reduction of thermal signature of the vehicle 10. In the thermal signature control mode 118, the thermal signature of the vehicle 10 may be prioritized over acoustic signature and fuel cell power. The thermal signature control mode 118 can advantageously be used in order to operate the fuel cell TMS 200 such that heat or temperature signature is reduced in order to reduce a detectability of the vehicle 10 by heat seeking weapons.

In the acoustic and thermal signature control mode 120, the controller 102 generates controls for the fuel cell TMS 200 such that the a difference or a delta between an acoustic signature produced by the vehicle 10 and an environmental acoustic noise level, as well as a difference or delta between a thermal signature produced by the vehicle 10 and ambient temperature. In this way, the acoustic and thermal signature control mode 120 is implemented in order to operate the fuel cell TMS 200 such that the vehicle 10 blends in with surrounding environments in terms of both acoustic or sound production as well as thermal, heat, or temperature signature. For example, if the vehicle 10 is in a very noisy environment, the fuel cell TMS 200 may be operated in a manner that allows greater noise generation. Similarly, if the vehicle 10 is in a hot environment, the fuel cell TMS 200 may be operated in a manner where the fuel cell TMS 200 is allowed to have a higher temperature. In this way, in the acoustic and thermal signature control mode 120, the controller 102 may operate the fuel cell TMS 200 in order to match or blend in with the environment in terms of both acoustic signature and thermal signature. The acoustic and thermal signature control mode 120 may be advantageous when the vehicle 10 is in a hostile environment and improved concealability is desired. In some embodiments, the acoustic and thermal signature control mode 120 may be a most restrictive mode in terms of fuel cell power which may limit the use of the acoustic and thermal signature control mode 120 to low power use cases.

In the mission mode 122, the controller 102 may implement a command and control technique using a meshed network of nearby vehicles 10 and corresponding controller 102. In some embodiments, the controller 102 is configured to automatically switch into the mission mode 122 in response to an assessed threat level identified by the mode selection manager 112 and/or the control signal generator 126. The assessed threat level may be determined by the mode selection manager 112 and/or the control signal generator 126 based on the sensor feedback obtained from sensors on an exterior of the vehicle 10. The threat level may be compared to a threshold threat level, and in response to the threat level exceeding the threshold threat level, the controller 102 transitions into the mission mode 122. In some embodiments, the threshold threat level is a user defined value or is determined based on a geographic location (e.g., obtained from a Global Positioning System). In some embodiments, the threat level is determined based on or responsive to an event such as a near miss of a weapon or projectile towards the vehicle 10, or a hit detection of a projectile into the vehicle 10. In some embodiments, the threat level is determined based on assessed environment data such as based on camera data obtained from cameras, Light Detection and Ranging (LIDAR) data, map data, a database of previously identified enemies and corresponding locations, etc. In some embodiments, the camera data or the LIDAR data are used by the mode selection manager 112 or an image analysis technique of the controller 102 in order to identify potential threats based on the camera data and/or the LIDAR data.

For example, the controller 102 may receive and use GPS data in order to identify when the vehicle 10 transports from a “green zone” (e.g., a location or zone in which enemy engagement is not expected) to a “red zone” (e.g., a location or zone in which enemy engagement is likely, predicted, or possible). For unmanned implementation of the vehicle 10, controller 102 may require a remote command from a user or operator to transition into the mission mode 122. For manned implementations of the vehicle 10, the controller 102 may transition into the mission mode 122 automatically. In some embodiments, the mission mode 122 reduces cognitive load on soldiers or occupants of the vehicle 10 and facilitates automatic transition of the vehicle 10 between different sub-modes. For example, the mission mode 122 may transition between a green zone sub-mode, a hostile environment sub-mode, an on-target sub-mode, and a vehicle engagement sub-mode. In some embodiments, the mission mode 122 automatically transitions between the various sub-modes described herein for a manned implementation of the vehicle 10 in order to reduce a cognitive load of the occupants of the vehicle 10 and ensure that the vehicle 10 transitions between the different modes without requiring user input. In some embodiments, the mission mode 122 is also configured to transition the vehicle 10 automatically between the acoustic signature control mode 116, the thermal signature control mode 118, the acoustic and thermal signature control mode 120, and/or the optimized efficiency mode 124.

In some embodiments, the controller 102 is configured to transition into the green zone sub-mode when the vehicle 10 is detected or determined to be in a zone or location at which a threat is not expected. The green zone sub-mode may be a preparatory mode in which the fuel cell 14 and the fuel cell TMS 200 are operated according to a regular mode of operation such that the battery 16 is maintained at a full charge, without adjusting or reducing operation of the fuel cell 14 and/or the fuel cell TMS 200 to reduce acoustic and/or thermal signature of the vehicle 10. In some embodiments, the controller 102 transitions into the hostile environment sub-mode in response to GPS location of the vehicle, a detected threat level of the vehicle 10, a near miss, a hit detection, etc. In some embodiments, the hostile environment sub-mode includes operating the controller 102 and the vehicle 10 according to the acoustic signature control mode 116, the thermal signature control mode 118, or the acoustic and thermal signature control mode 120 in order to facilitate improved concealability of the vehicle 10. For example, the controller 102 may operate according to the thermal signature control mode 118 in order to reduce a heat signature of the vehicle 10 and reduce a likelihood of detection by thermal cameras or heat-seeking weaponry of an enemy or hostiles. In some embodiments, the controller 102 transitions into any of the sub-modes of the mission mode 122 in response to a detection of a type of equipment of the enemy or hostiles. For example, if it is identified that the enemy or hostile have thermal cameras, the controller 102 may transition into the thermal signature control mode 118.

In some embodiments, the on-target sub mode includes operating the vehicle 10 (e.g., the fuel cell 14 and the fuel cell TMS 200) according to the acoustic and thermal signature control mode 120. In some embodiments, the controller 102 transitions into the on-target sub mode in response to locking onto a target, or detecting that an enemy is attempting to lock on-target to the vehicle 10.

In some embodiments, the vehicle engagement sub-mode includes operating the fuel cell 14 and the fuel cell TMS 200 in order to provide full power and maintain full charge of the battery 16. In some embodiments, the vehicle engagement sub-mode is activated in response to the controller 102 detecting a near miss of a projectile or weapon, or a detection of a hit of a projectile or weapon at the vehicle 10.

In some embodiments, the optimized efficiency mode 124 is implemented by the controller 102 in order to control operation of the fuel cell TMS 200 and/or the fuel cell 14 in order to minimize energy consumption of the vehicle 10 by utilizing environmental conditions. In some embodiments, the optimized efficiency mode 124 is implemented in a low power silent or silent watch mode. In some embodiments, the optimized efficiency mode 124 includes operating the fuel cell TMS 200 in order to take advantage of cooler ambient temperatures in order to charge the battery 16 without operating cooling devices of the fuel cell TMS 200. In some embodiments, use of the fuel cell 14 to charge the battery 16 is limited when ambient temperatures increase or exceed a threshold. In some embodiments, the controller 102 is configured to, when operating according to the optimized efficiency mode 124, consider efficiency or impacts of the fuel cell TMS 200 related to ambient humidity, effects of solar loading, etc., or more generally, environmental conditions

### Acoustic Signature Control Mode

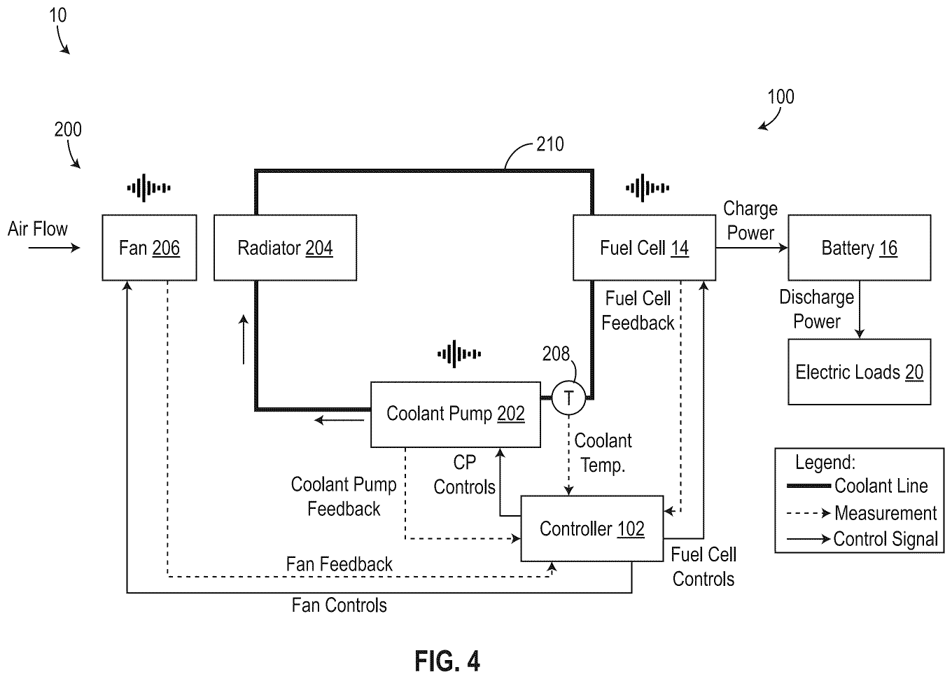

Referring to FIG. 4, the fuel cell TMS 200 includes a radiator 204 (e.g., a heat exchanger), the fuel cell 14, a coolant pump 202 (e.g., a compressor, a primary mover, etc.), a fan 206, and coolant lines 210 (e.g., pipes, tubular members, conduits, hoses, etc.), according to some embodiments. The coolant pump 202 is configured to operate to drive coolant through the coolant lines 210 to the radiator 204. The fan 206 is configured to blow air across the radiator 204 in order to facilitate cooling of the coolant in the coolant lines 210, which is then provided to the fuel cell 14 (e.g., to a heat exchanger of the fuel cell 14) in order to provide cooling for the fuel cell 14. The coolant is returned from the fuel cell 14 to the coolant pump 202 after absorbing heat from the fuel cell 14 and thereby cooling the fuel cell 14.

FIG. 4 illustrates the controller 102 operating the coolant pump 202 and the fan 206 (e.g., the fuel cell TMS 200) and the fuel cell 14 according to the acoustic signature control mode 116 as described above with reference to FIG. 3. The fuel cell TMS 200 includes a temperature sensor 208 that is configured to measure a temperature of the coolant as the coolant returns from the fuel cell 14 to the coolant pump 202 (e.g., at an outlet of the fuel cell 14, at an inlet of the coolant pump 202, at a position between the inlet of the coolant pump 202 and the outlet of the fuel cell 14, etc.). The controller 102 is configured to obtain the temperature of the coolant, shown as coolant temperature. The controller 102 is configured to use the coolant temperature to determine controls for the fan 206 (e.g., shown as fan controls), controls for the coolant pump 202 (e.g., coolant pump controls), and controls for the fuel cell 14 (e.g., fuel cell controls) in order to minimize or reduce acoustic or noise output of the coolant pump 202, the fan 206, and the fuel cell 14. In some embodiments, the controller 102 is also configured to receive feedback signals from the fan 206, shown as fan feedback, feedback signals from the coolant pump 202, shown as coolant pump feedback, and feedback signals from the fuel cell 14, shown as fuel cell feedback. The controller 102 is configured to use the coolant temperature, the fan feedback, the coolant pump feedback, and the fuel cell feedback in order to determine the controls for the fan 206, the coolant pump 202, and the fuel cell 14 according to the acoustic signature control mode 116.

In some embodiments, the fan feedback includes measurements of a fan speed, an airflow rate, a duty or duty cycle of the fan 206, a power consumption of the fan 206, etc. In some embodiments, the coolant pump feedback includes measurements of a coolant pump speed, a flow rate of the coolant through the coolant pump 202, a duty or duty cycle of the coolant pump 202, a power consumption of the coolant pump 202, etc. In some embodiments, the fuel cell feedback includes measurements of fuel cell power and/or current produced by the fuel cell 14.

In some embodiments, the fan controls that are generated by the controller 102 include control settings, parameters, signals, or setpoints of the fan speed of the fan 206, the air flow rate of the fan 206, the duty cycle of the fan 206, and/or the power consumption of the fan 206. In some embodiments, the coolant pump controls that are generated by the controller 102 include control settings, parameters, signals, or setpoints of the coolant pump speed, the flow rate of the coolant pump 202, the duty cycle of the coolant pump 202, and/or the power consumption of the coolant pump 202. In some embodiments, the fuel cell controls generated by the controller 102 include control settings, parameters, signals, or setpoints of the fuel cell output power, and/or the fuel cell current.

Main sources of audible noise in a fuel cell system may include fuel cell air blowers (or compressors) (e.g., the fuel cell 14 or the heat exchanger associated with the fuel cell 14), coolant pumps (e.g., the coolant pump 202), and cooling fans (e.g., the fan 206). In addition, frequency or pulse width modulated (PWM) controlled devices such as solenoids of the fuel cell TMS 200 that make noise outside of an audible range of the human ear may also be considered, by the controller 102, as a part of an overall acoustic signature of the fuel cell TMS 200. The controller 102 is configured to, when operating according to the acoustic signature control mode 116, generate controls (e.g., the fan controls, the coolant pump controls, and the fuel cell controls) in order to control the fuel cell TMS 200 (and other systems or components of the vehicle 10) such that the fuel cell TMS 200 and noise-producing components thereof operate such that the overall acoustic signature of the fuel cell TMS 200 (or the vehicle 10) are below a threshold acoustic level. In some embodiments, the threshold acoustic level is a user defined threshold. In some embodiments, the threshold acoustic level is determined by the controller 102 as a function of one or more vehicle settings (e.g., speed of an engine or primary mover of the vehicle 10 such as the electric motor 302, speed of the vehicle 10, etc.). Advantageously, the controller 102 may generate the fan controls, the coolant pump controls, and the fuel cell controls such that the overall acoustic signature of the vehicle 10 is maintained at or below the threshold acoustic level. The threshold acoustic level may be a static value, or may be a variable threshold based on any of the other vehicle settings or factors described herein.

In some embodiments, the controller 102 is configured to use any of the coolant pump feedback, the fan feedback, or the fuel cell feedback in order to estimate the overall acoustic signature of the fuel cell TMS 200 (or the vehicle 10). The controller 102 is configured to determine the fan controls, the coolant pump controls, and the fuel cell controls in order to maintain the overall acoustic signature below the threshold acoustic level, according to some embodiments.

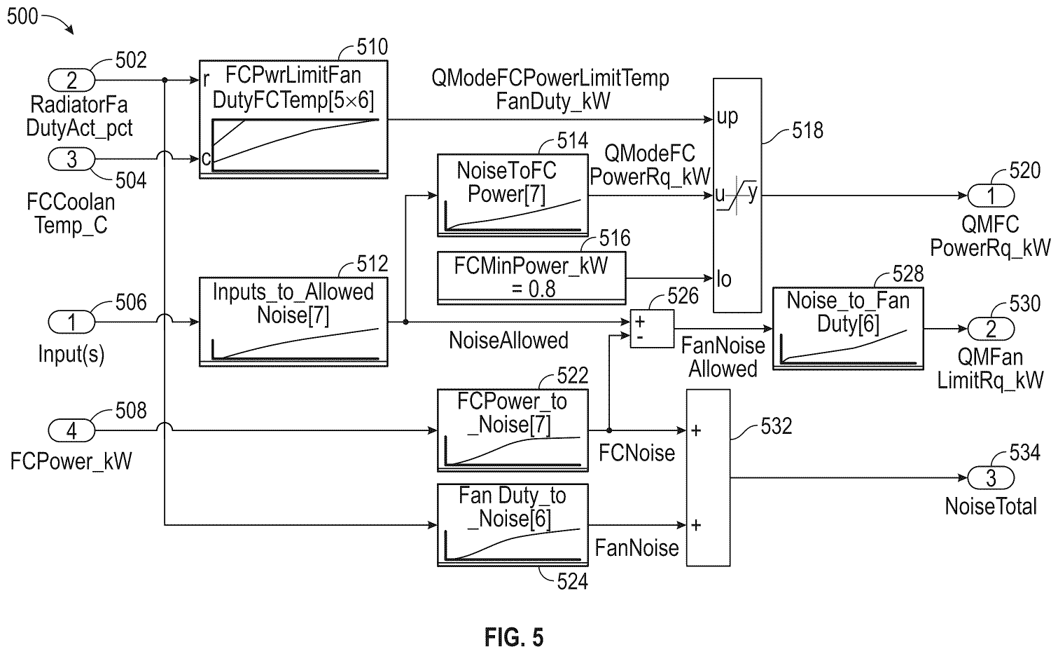

Referring to FIG. 5, a block diagram 500 illustrating functionality of the controller 102 when operating according to the acoustic signature control mode 116 includes a fan input 502, a coolant temperature input 504, one or more input(s) 506, and a fuel cell power input 508, according to some embodiments. In some embodiments, the fan input 502 is the duty cycle of the fan 206. In some embodiments, the coolant temperature input is the coolant temperature provided by the temperature sensor 208. In some embodiments, the input 506 is a parameter or measurement that is used to determine the threshold acoustic level. The input 506 may be or include a vehicle speed input obtained from the tractive element sensor 312 (e.g., a wheel speed sensor), the transmission sensor 310, and/or the sensor 308 of the primary mover of the vehicle 10 (e.g., the electric motor 302). It should be understood that while the vehicle 10 as described herein is described as including the electric motor 302 as the primary mover, the vehicle 10 may alternatively or additionally include an internal combustion engine (e.g., a gasoline engine, a diesel engine, etc.) that provides torque for the tractive elements 306. In some embodiments, the inputs 506 are or include sensor data, environmental conditions, ambient noise levels, a threat level detected in an area, etc.

Referring still to FIG. 5, the block diagram 500 includes a first transfer function 510 that receives the fan input 502 and the coolant temperature input 504 and outputs a power limit for the fuel cell 14 (e.g., an upper limit for the fuel cell 14). In some embodiments, the first transfer function 510 is a multi-dimensional graph, look-up table, equation, etc., that is configured to receive the fan input 502 (e.g., the current duty cycle of the fan 206 in a percentage) and the coolant temperature input 504 (e.g., the coolant temperature as measured in degrees Celsius, Kelvin, or Fahrenheit by the temperature sensor 208), and output or determine the upper power limit for the fuel cell 14 (e.g., in kilowatts).

The block diagram 500 also includes a second transfer function 512 that receive the inputs 506 and outputs a maximum noise allowed (e.g., the threshold acoustic level), according to some embodiments. The second transfer function 512 may be an equation, a lookup table, a curve, etc., that expresses a relationship between the input(s) 506 and the maximum noise allowed. In some embodiments, the second transfer function 512 has a generally linear relationship between the vehicle speed input 506 and the maximum noise allowed.

The block diagram 500 also includes a third transfer function 522 that receives the fuel cell power input 508 and outputs an estimated fuel cell noise, according to some embodiments. The third transfer function 522 may similarly be an equation, a lookup table, a curve, etc., that expresses a relationship between the fuel cell power input 508 and the estimated fuel cell noise. The block diagram 500 also includes a fourth transfer function 524 that receives the fan input 502 (e.g., the duty cycle of the fan 206) and outputs an estimated fan noise, according to some embodiments. The fourth transfer function 524 may similarly be an equation, a lookup table, a curve, etc., that expresses a relationship between the fan input 502 and the estimated fan noise.

The block diagram 500 includes a minimum fuel cell threshold block 516 that includes a value that defines a lower boundary or threshold of fuel cell power of the fuel cell 14 (e.g., a fuel cell power lower limit), according to some embodiments. In some embodiments, the minimum fuel cell threshold block 516 is a preset or predetermined value. In some embodiments, the minimum fuel cell threshold block 516 includes a user-set value. The block diagram 500 also includes a fifth transfer function 514 that receives the maximum noise allowed from the second transfer function 512, and outputs a fuel cell power requirement for the fuel cell 14. The fifth transfer function 514 may be an equation, a lookup table, a curve, etc., that expresses a relationship between the maximum noise allowed and the fuel cell power requirement for the fuel cell 14. In some embodiments, the fuel cell power requirement for the fuel cell 14 as output by the fifth transfer function 514 is an unbounded or pre-bounded signal or value.

The block diagram 500 includes a saturation or limit block, shown as saturation block 518, according to some embodiments. In some embodiments, the saturation block 518 is configured to receive the output of the first transfer function 510 (e.g., the upper power limit for the fuel cell 14) as an upper threshold value (e.g., “up”), the output of the minimum fuel cell threshold block 516 (e.g., the lower power limit for the fuel cell 14) as a lower threshold value (e.g., “lo”), and the fuel cell power requirement (e.g., the output of the fifth transfer function 514) as the input (e.g., “u”). In some embodiments, the saturation block 518 uses the logic (1) IF up>u>lo THEN y=u, (2) IF u<lo THEN y=lo, (3) IF u>up THEN y=up where u is the fuel cell power requirement provided by the fifth transfer function 514, up is the upper power limit for the fuel cell 14, lo is the lower power limit for the fuel cell 14, and y is the output of the saturation block 518. In some embodiments, the output of the saturation block 518 is a fuel cell power requirement 520 which is used by the fuel cell 14 in order to operate according to the acoustic signature control mode 116.

The block diagram 500 also includes a difference block 526 that is configured to receive the maximum noise allowed from the second transfer function 512, and the estimated fuel cell noise from the third transfer function 522. In some embodiments, the difference block 526 determines a difference between the maximum noise allowed and the estimated fuel cell noise. More specifically, the difference block 526 subtracts the fuel cell from the maximum noise allowed in order to determine an amount of the maximum noise allowed that the fan 206 can “use.” The difference block 526 outputs the difference as an allowed fan noise value, and provides the allowed fan noise value to a sixth transfer function 528. The sixth transfer function 528 may be an equation, a lookup table, a curve, etc., that is configured to define a relationship between the allowed fan noise value and a duty cycle for the fan 206, shown as fan duty cycle output 530. The fan duty cycle output 530 may be provided to the fan 206 by the controller 102 as the fan controls.

The block diagram 500 also includes a summation block 532 that receives the estimated fuel cell noise from the third transfer function 522 and the estimated fan noise from the fourth transfer function 524. The summation block 532 is configured to sum or add the estimated fuel cell noise and the estimated fan noise and provide a total noise output 534 (e.g., the summation of the estimated fuel cell noise and the estimated fan noise). It should be understood that while block diagram 500 is shown to determine the total noise output 534 as a function of two noise producing devices (e.g., the fan 206 and the fuel cell 14), the block diagram 500 may also be configured to account for noise produced by the coolant pump 202 and delegate a portion of the maximum noise allowed for operation of the coolant pump 202. In this way, the “maximum noise allowed” may indicate an available amount of noise that the coolant pump 202, the fuel cell 14, and the fan 206 can “use,” and the controls of the fan 206, the fuel cell 14, and the coolant pump 202 can be operated to “use” portions of the maximum noise allowed.

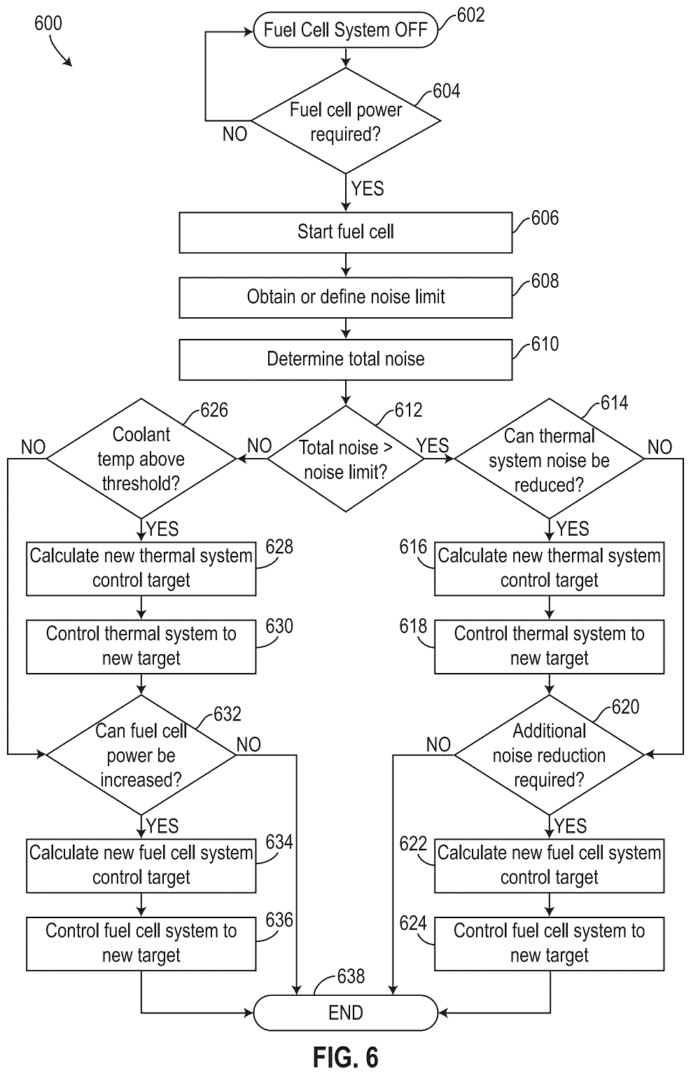

Referring to FIG. 6, a flow diagram of a process 600 for controlling a fuel cell (e.g., the fuel cell 14) and a fuel cell TMS (e.g., the fuel cell TMS 200) in order to achieve a desired or allowable noise level includes steps 602-638, according to some embodiments. In some embodiments, the process 600 illustrates the functionality of the controller 102 when implementing the acoustic signature control mode 116. The process 600 may be performed by the controller 102 in order to control operation of the fuel cell 14, the fan 206, and the coolant pump 202. It should be understood that the “thermal system” as described herein with reference to FIG. 6 may refer to the fuel cell TMS 200.

The process 600 includes starting at a fuel cell system off (step 602), and determining if fuel cell power is required (step 604), according to some embodiments. In some embodiments, if fuel cell power is not required (step 604, “NO”), process 600 returns to step 602. If fuel cell power is required (step 604, “YES”), process 600 proceeds to step 606. In some embodiments, step 604 includes comparing a current power level in the battery 16 to a maximum power level of the battery 16, and if the current power or charge level in the battery 16 is not the maximum power level, determining that fuel cell power is required. In some embodiments, step 604 includes determining if the charge level of the battery 16 deviates from a maximum charge level by a threshold amount.

The process 600 includes starting the fuel cell (step 606) and obtaining or defining a noise limit (step 608), according to some embodiments. In some embodiments, starting the fuel cell includes providing activation controls or activation signals to the fuel cell 14. In some embodiments, step 608 includes determining a maximum noise allowed. The maximum noise allowed or the noise limit may be a user-defined parameter, or may be determined based on an operational parameter of the vehicle 10. For example, the noise limit may be determined by the controller 102 by using the techniques of blocks 506 and 512 of the block diagram 500 as described in greater detail above with reference to FIG. 5. The noise limit may be determined by an algorithm of the controller 102 based on sensor data or control settings of the vehicle 10 (e.g., vehicle speed, engine or motor speed, etc.).

The process 600 includes determining a total noise (step 610), according to some embodiments. The total noise may be an estimation of noise produced by one or more components or devices of the vehicle 10, including but not limited to, the fuel cell 14, actuators, the fuel cell TMS 200, etc. In some embodiments, the total noise is a summation of an estimated noise produced by the fuel cell 14, an estimated noise produced by the coolant pump 202, and/or an estimated noise produced by the fan 206. The estimated noise produced by the fuel cell 14 may be determined based on a blower speed of the fuel cell 14 and a power output of the fuel cell 14. The estimated noise produced by the fan 206 may be determined based on a speed of the fan 206. Similarly, the noise produced by the coolant pump 202 may be determined based on the speed of the coolant pump 202, power drawn by the coolant pump 202, etc. In some embodiments, the total noise is estimated by the controller 102 using any of the techniques described in greater detail above with reference to FIG. 5 in order to determine the total noise output 534.

The process 600 includes determining if the total noise exceeds the noise limit (step 612), according to some embodiments. In some embodiments, step 612 is performed by comparing the total noise as obtained in step 610 to the noise limit as obtained in step 608. In some embodiment, step 612 is performed by determining a difference between the total noise and the noise limit and determining if the difference is greater than or less than zero. In response to the total noise exceeding the noise limit (step 612, “YES”), process 600 proceeds to step 614 in order to reduce power of the fuel cell 14 and to reduce noise of the fuel cell TMS 200. In response to the total noise being less than the noise limit (step 612, “NO”), process 600 proceeds to step 626 in order to increase the power of the fuel cell 14 and to increase operation of the fuel cell TMS 200 to produce additional noise (without allowing the total noise to exceed the noise limit).

The process 600 includes determining if a coolant temperature is above a threshold (step 626), according to some embodiments. In some embodiments, the coolant temperature is the coolant temperature provided by the temperature sensor 208 of the fuel cell TMS 200. In some embodiments, the threshold is a maximum allowable threshold that is a predetermined value. In response to the coolant temperature being above the threshold, (step 626, “YES”), process 600 proceeds to step 628. In response to the coolant temperature being below the threshold, (step 626, “NO”), process 600 proceeds to step 632.

The process 600 includes calculating a new thermal system control target (step 628) and controlling the thermal system to the new target (step 630), according to some embodiments. In some embodiments, step 628 is performed in response to the coolant temperature being above the threshold (step 626, “YES”). In some embodiments, step 628 is performed using a lookup table in order to calculate a new thermal system control target (e.g., a new fan speed target). In some embodiments, The new thermal system control target is determined by using a reverse thermal system noise table where an input is noise and an output is a thermal system control requirement. In some embodiments, step 628 is performed by the controller 102 in order to determine new controls for the fan 206 and the coolant pump 202 (e.g., to increase speed of the fan 206 and the coolant pump 202) of the fuel cell TMS 200. In some embodiments, step 628 is performed such that the operation of the fan 206 is increased to provide additional cooling to the radiator 204, and operation of the coolant pump 202 is increased to provide increased rate at which coolant is circulated through the coolant lines 210. Step 628 may be performed using the lookup tables in order to determine increases for the fan 206 and/or the coolant pump 202 such that the fan 206 and the coolant pump 202 are predicted to, in summation, output additional noise that is substantially equal to the difference in step 612. In some embodiments, step 628 may be performed by estimating a thermal system noise increase which is equal to a thermal system noise at the new control target minus the thermal system noise (the current thermal system noise as determined in step 610).

The process 600 includes determining if the fuel cell power can be increased (step 632), according to some embodiments. In some embodiments, step 632 includes determining if the total noise is equal to or less than the noise limit. For example, if, at step 526, the coolant temperature was determined to not be above the threshold, then the total noise may be significantly less than the noise limit and the fuel cell power may be increased such that additional noise is output by the fuel cell 14. In response to determining that the fuel cell power can not be increased (e.g., that the total noise equals the total noise limit, and/or that the fuel cell is already operating at maximum power) (step 632 “NO), process 600 proceeds to step 638. In response to determining that the fuel cell power can be increased (e.g., that the total noise does not equal to the total noise limit and/or that the fuel cell is not yet operating at maximum power) (step 632, “YES”), process 600 proceeds to step 634. The coolant temperature may be a temperature measured of the coolant used to cool the fuel cell 14 at a hottest location, or may be a temperature measured at the fuel cell 14.

The process 600 includes calculating a new fuel cell system control target (step 634) and controlling the fuel cell system to the new target (step 636), according to some embodiments. In some embodiments, step 634 includes using a lookup table to calculate the fuel cell power target. The lookup table may be a reverse fuel cell system noise table with an input of noise (e.g., a difference between total noise and the noise limit) and an output of fuel cell power (e.g., the new fuel cell system control target). In some embodiments, step 634 includes calculating the new fuel cell system control target by determining the fuel cell system noise increase which is a difference between a predicted fuel cell system noise at a new control target minus the current fuel cell system noise. In some embodiments, step 634 includes using a lookup table in order to determine an increase or the new fuel cell system control target based on the difference between the predicted fuel cell system noise at the new control target and the current fuel cell system noise. In response to completing step 636, the process 600 ends at step 638.

The process 600 includes determining if thermal system noise can be reduced (step 614) in response to determining that the total noise exceeds the noise limit (step 612, “YES”). In some embodiments, step 614 is performed similarly to step 626 and includes identifying if the fuel cell coolant temperature is above the threshold. If the fuel cell coolant temperature (e.g., the temperature measured by the temperature sensor 208) is less than the threshold, this may indicate that the thermal system noise can be reduced (step 614, “YES”). If the fuel cell coolant temperature is greater than or equal to the threshold, this may indicate that the thermal system noise can not be reduced (step 614, “NO”). In response to determining that the thermal system noise can not be reduced (step 614, “NO”), process 600 proceeds to step 620. In response to determining that the thermal system noise can be reduced (step 614, “YES”), process 600 proceeds to step 616.

The process 600 includes calculating a new thermal system control target (step 616) and controlling the thermal system to the new target (step 618) in response to determining that the thermal system noise can be reduced (step 614, “YES”), according to some embodiments. In some embodiments, step 616 is performed by using a lookup table to calculate the new thermal system control target. In some embodiments, the new thermal system control target includes a new fan speed target that is determined using the lookup table. In some embodiments, step 616 is performed by using a reverse thermal system noise table where an input is noise and an output is a thermal system control requirement. In some embodiments, step 616 is performed by determining a thermal system noise reduction which is a difference between a thermal system noise and a thermal system noise at the new control target (e.g., Thermal System Noise Reduction=Thermal System Noise−Thermal System Noise at New Control Target).

The process 600 includes determining if additional noise reduction is required (step 620), according to some embodiments. In some embodiments, step 620 includes determining if an additional noise reduction parameter is greater than zero. In some embodiments, step 620 includes determining the additional noise reduction parameter by subtracting a thermal system noise reduction and the noise limit from the total noise. In some embodiments, the thermal system noise reduction is the noise reduction achieved in steps 616 and 618. In some embodiments, in response to determining that additional noise reduction is required or that additional noise reduction of the fuel cell can be achieved (step 620, “YES”), process 600 proceeds to step 622. In some embodiments, in response to determining that additional noise reduction is not required or that additional noise reduction of the fuel cell can not be achieved (step 620, “NO”), process 600 proceeds to the end of process 600 at step 638.

The process 600 includes calculating a new fuel cell system control target (step 622) and controlling the fuel cell system to the new target (step 624), according to some embodiments. In some embodiments, step 622 is performed by using a lookup table in order to calculate the fuel cell system control target. The fuel cell system control target may be a fuel cell power target for the fuel cell 14. In some embodiments, the fuel cell power target is determined by using a reverse fuel cell system noise table that receives an input of noise, and outputs fuel cell power. In some embodiments, the fuel cell system noise reduction is determined based on the fuel cell system noise and the fuel cell system noise at the new control target. More specifically, the fuel cell system noise reduction may be determined as Fuel Cell System Noise Reduction=Fuel Cell System Noise-Fuel Cell System Noise at New Control Target. In response to performing step 624, process 600 ends at step 638.

### Thermal and Acoustic Signature Control Mode

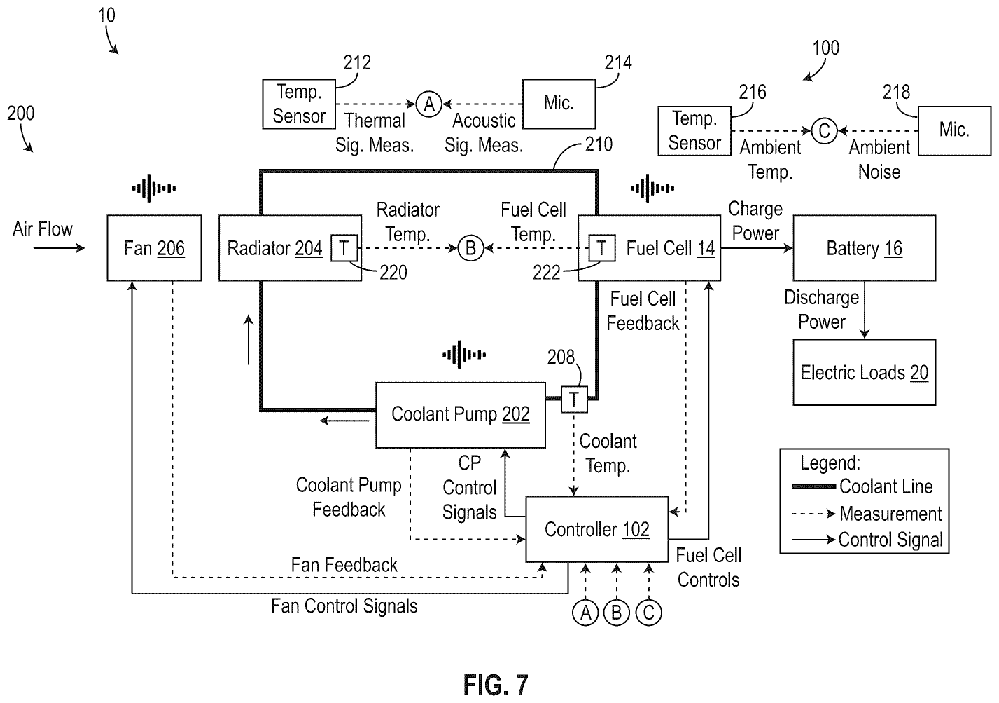

Referring to FIG. 7, the fuel cell TMS 200, the control system 100, or the vehicle 10 may additionally include an ambient temperature sensor 216 and an ambient noise sensor 218 (e.g., a microphone), according to some embodiments. In some embodiments, the ambient temperature sensor 216 is configured to measure ambient temperature at one or more locations external to the vehicle 10 and provide the measurement of the ambient temperature to the controller 102. Similarly, the ambient noise sensor 218 may measure surrounding or ambient noise levels at one or more locations external to the vehicle 10 and provide the measurement of the surrounding or ambient noise levels to the controller 102. The control system 100 may also include a thermal signature temperature sensor 212 and an acoustic signature sensor 214 (e.g., a microphone). The thermal signature temperature sensor 212 is configured to measure a thermal signature of the vehicle 10, or more specifically, a thermal signature of the fuel cell TMS 200, and provide the measurement of the thermal signature to the controller 102. Similarly, the acoustic signature sensor 214 (e.g., a microphone) may measure the acoustic signature of the vehicle 10, or more specifically, of the fuel cell TMS 200 and provide the measurement of the acoustic signature to the controller 102. In some embodiments, the fuel cell TMS 200 also includes a radiator temperature sensor 220 that is configured to measure a temperature of the radiator 204. The radiator temperature sensor 220 is configured to provide the measurement of the temperature of the radiator 204 to the controller 102, according to some embodiments. Similarly, the fuel cell TMS 200 includes a fuel cell temperature sensor 222 that is configured to measure a temperature of the fuel cell 14 and provide the measurement of the fuel cell temperature to the controller 102.

FIG. 7 illustrates the fuel cell TMS 200 operated by the controller 102 according to the acoustic and thermal signature control mode 120, according to some embodiments. For example, vehicles and systems may emit a thermal signature based on various factors including thermal system temperature and component temperature. When vehicles and systems are operational, the thermal signature may be greater than the temperature of surrounding ambient environment. This can result in thermal imaging cameras and sensors more easily detecting the presence of the vehicle and targeting the vehicle or systems of the vehicle. Similarly, vehicles and systems can be identified by their acoustic signatures. Advantageously, the acoustic signature and thermal signature may be controlled in the acoustic and thermal signature control mode 120 such that the vehicle 10 blends in with the surroundings (e.g., the thermal signature and the acoustic signature match the surrounding or ambient thermal and acoustic characteristics). In this way, the controller 102 may use any of the techniques described in greater detail above with reference to FIGS. 3 and 4-6 (e.g., the techniques of the acoustic signature control mode 116) in order to reduce a difference between the acoustic signature of the vehicle 10 and the ambient acoustic characteristics. The controller 102 may similarly use any of the techniques of the thermal signature control mode 118 in order to reduce a difference between the thermal signature of the vehicle 10 and the ambient or surrounding thermal characteristics. Advantageously, the acoustic and thermal signature control mode 120 can be implemented to improve concealability of the vehicle 10 in terms of acoustic signature and thermal signature, which can reduce a likelihood of detection and targeting of the vehicle 10. In some embodiments, when operating according to the acoustic and thermal signature control mode 120, the controller 102 operates the fuel cell 14 and the fuel cell TMS 200 such that a delta to ambient threshold for each of the thermal signature and acoustic signature of the vehicle 10 are reduced in order to facilitate the vehicle 10 blending in with surrounding environment.

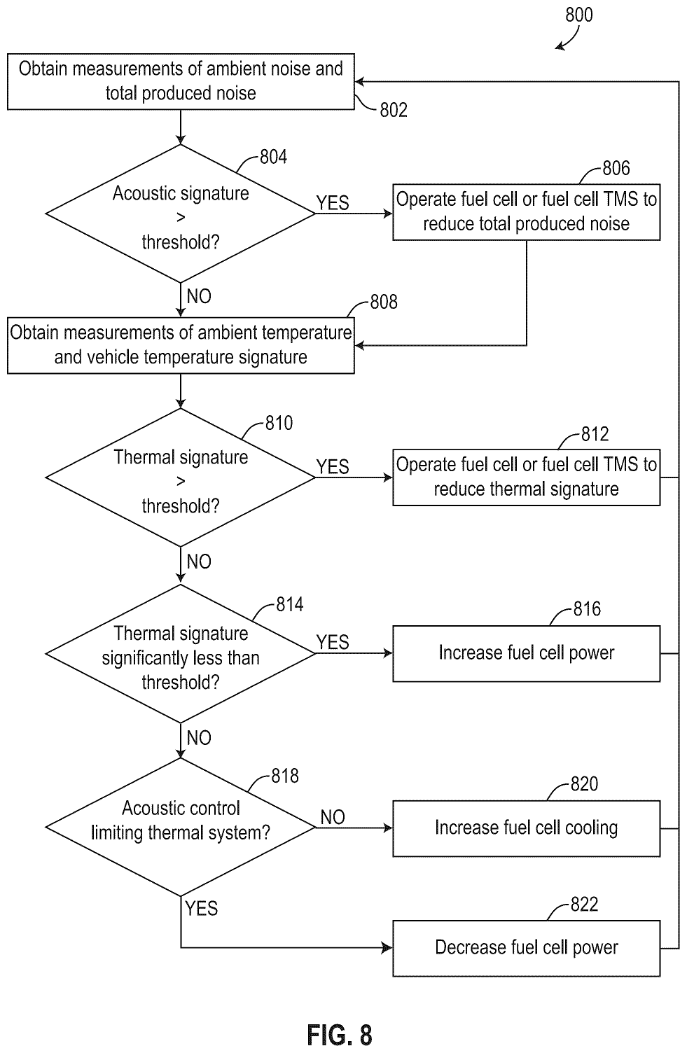

Referring to FIG. 8, a flow diagram of a process 800 for implementing the acoustic and thermal signature control mode 120 includes steps 802-822, according to some embodiments. In some embodiments, the process 800 is performed by the controller 102. The process 800 may be performed in order to reduce a difference between thermal signature and acoustic signature of the vehicle 10 and ambient thermal and acoustic conditions. For example, the process 800 may be implemented by the controller 102 such that the vehicle 10 does not produce heat or have a temperature (e.g., a thermal signature) of more than 20 degrees Celsius above an ambient temperature, and so that the vehicle 10 does not produce noise that is more than 20 decibels (dB) above ambient noise levels. In some embodiments, various thresholds of the process 800 are adjusted in real-time based on changes in ambient temperature or noise levels. In some embodiments, the ambient temperature sensor 216 and the ambient noise sensor 218 are configured to obtain ambient temperature and noise levels. In some embodiments, the thermal signature and the acoustic signature are measured values of temperature and acoustic levels of the vehicle 10 as provided by the temperature sensor 212 and the acoustic signature sensor 214. It should be understood that the “thermal signature” may reference a temperature value of the vehicle 10 or component of the vehicle 10, or may refer to a difference between the temperature value of the vehicle 10 or the component of the vehicle 10 and the ambient temperature. Similarly, the “acoustic signature” may refer to a noise level of the vehicle 10 or component of the vehicle 10, or may refer to a difference between the noise level of the vehicle 10 or the component of the vehicle 10 and the ambient noise level. The measurements of the temperature sensor 212, the acoustic sensor 214, the temperature sensor 216, and the acoustic sensor 218 may be used to provide closed loop control of the fuel cell TMS 200, the fuel cell 14, various systems of the vehicle 10 (e.g., the driveline 300), and any thermal system of the vehicle 10. In some embodiments, any of the sensors described herein (e.g., the acoustic sensor 218, the temperature sensor 216, etc.) are on-board the vehicle. In some embodiments, any of the sensors described herein to detect a thermal and/or acoustic signature of the vehicle 10, or any other sensors, are in a remote location such as a drone, an aircraft, etc.

Referring generally to FIG. 8, the controller 102 may implement an acoustic signature control loop and a thermal signature control loop, according to some embodiments. The acoustic signature control loop may be operated based on total noise measured (e.g., the sensor data provided by the acoustic signature sensor 204). If the total noise measured does not exceed a threshold, then no limitations are set on the fuel cell 14, the fuel cell TMS 200, or thermal system operations of the vehicle 10. If the total noise measured is near or above the threshold, the fuel cell 14 and/or fuel cell TMS 200 are controlled to reduce noise. Similarly, in the thermal signature control loop, the controller 102 operates based on the temperature measurements provided by the temperature sensor 212. It should be understood that the temperature measurements of the thermal signature of the vehicle 10 can be obtained from a single temperature sensor 212, or multiple temperature sensors 212. If the measured temperature (e.g., provided by the temperature sensor 212) is below a thermal signature threshold, then power of the fuel cell 14 may be allowed to increase. If the measured temperature (e.g., provided by the temperature sensor 212) is near or below the threshold and the acoustic signature control is not limiting the fuel cell TMS 200, the fuel cell TMS 200 may be allowed to increase (e.g., increase cooling by increasing duty cycle and speed of the fan 206, the coolant pump 202, etc.). If the measured temperature (e.g., provided by the temperature sensor 212) is near or below the threshold and the acoustic signature control is limiting the fuel cell TMS 200, then the power of the fuel cell 14 may be reduced based on a balance between a required heat rejection of the fuel cell 14 required power of the fuel cell 14.

The process 800 includes obtaining measurement of ambient noise and total produced noise (step 802) and determining if an acoustic signature exceeds a threshold (step 804), according to some embodiments. In some embodiments, the ambient noise is measured by the noise sensor 218 and the total produced noise is measured by the noise sensor 214. In response to the acoustic signature exceeding the threshold (e.g., an acoustic signature threshold determined based on the ambient noise), the process 800 proceeds to step 806. In response to the acoustic signature being less than the threshold, the process 800 proceeds to step 808.

The process 800 includes operating the fuel cell or the fuel cell TMS to reduce total produced noise (step 806), according to some embodiments. In some embodiments, step 806 includes reducing power output of the fuel cell 14 and/or adjusting operation of the coolant pump 202 and the fan 206 in order to reduce the total produced noise. In response to performing step 806, process 800 proceeds to step 808.

The process 800 includes obtaining measurements of ambient temperature and vehicle temperature signature (step 808) and determining if the thermal signature of the vehicle exceeds a threshold (step 810), according to some embodiments. Step 808 may be performed in response to step 806 or in response to step 804 if the acoustic signature is not greater than the threshold. In some embodiments, step 810 is performed similarly to step 804 but using temperature values instead of acoustic levels. If the thermal signature is greater than the threshold (step 810, “YES”), process 800 proceeds to step 812. If the thermal signature is less than the threshold (step 810, “NO”), process 800 proceeds to step 814.

The process 800 includes determining if the thermal signature is significantly less than the threshold (step 814), according to some embodiments. If the thermal signature is significantly less than the threshold (e.g., by a predetermined amount), the process 800 proceeds to step 816 in which the fuel cell 14 is operated to increase fuel power. If the thermal signature is not significantly less than the threshold (step 814, “NO”), process 800 proceeds to step 818.

The process 800 includes determining if acoustic signature control is limiting the thermal system (e.g., the fuel cell TMS 200) (step 818), according to some embodiments. If the acoustic signature control (e.g., the operation of the fuel cell TMS 200 resulting from steps 802-808), is not limiting the thermal system (step 818, “NO”), process 800 proceeds to step 820 at which point cooling of the fuel cell 14 is increased (e.g., by operating the fan 206 and the coolant pump 202 to increase). If the acoustic signature control is limiting the thermal system (step 818, “YES”), the process 800 proceeds to step 822 at which point power output of the fuel cell 14 is decreased.

### Thermal Signature Control Mode

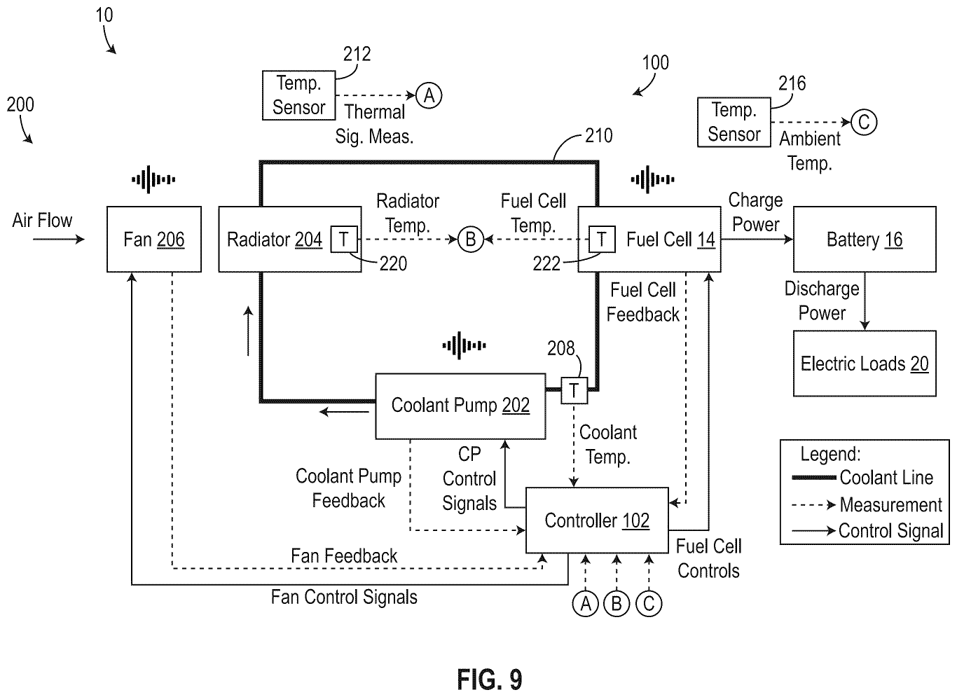

Referring to FIG. 9, the controller 102 may control the fuel cell TMS 200 according to the thermal signature control mode 118, according to some embodiments. In some embodiments, the fuel cell TMS 200 can be operated according to the thermal signature control mode 118 based on measurements provided by the temperature sensor 212 and the temperature sensor 216. The controller 102 may control the fuel cell 14 and the fuel cell TMS 200 such that the fuel cell 14 and the fuel cell TMS 200 do not exceed a temperature threshold. In some embodiments, the controller 102 is configured to control the fuel cell 14 and the fuel cell TMS 200 in order to keep the thermal signature of the vehicle 10 below a threshold. The controller 102 may also operate other components or devices of the vehicle 10 such that the thermal signature of the vehicle 10 does not exceed the threshold. In some embodiments, the controller 102 operates the fuel cell 14 and the fuel cell TMS 200 in order to maintain cooling to achieve power or performance targets, while maintaining the thermal or temperature signature below a threshold. If the fuel cell TMS 200 reaches a point where the controller 102 cannot keep the thermal signature below the threshold, power of the fuel cell 14 is reduced. Advantageously, the thermal signature control mode 118 may reduce a likelihood of the vehicle 10 being detected and/or targeted based on thermal signature (e.g., by heat seeking munitions). When operating according to the thermal signature control mode 118, the controller 102 may operate the fuel cell 14 and the fuel cell TMS 200 such that thermal signature minimization is prioritized above power output of the fuel cell 14 and above acoustic signature. In some embodiments, the threshold that the thermal signature of the vehicle 10 is maintained below determines the power of the fuel cell 14 and corresponding operation of the fuel cell TMS 200. In some embodiments, the controller 102, when operating according to the thermal signature control mode 118, allows the fuel cell 14 to output as much power as possible without the thermal signature of the vehicle 10 exceeding the threshold.

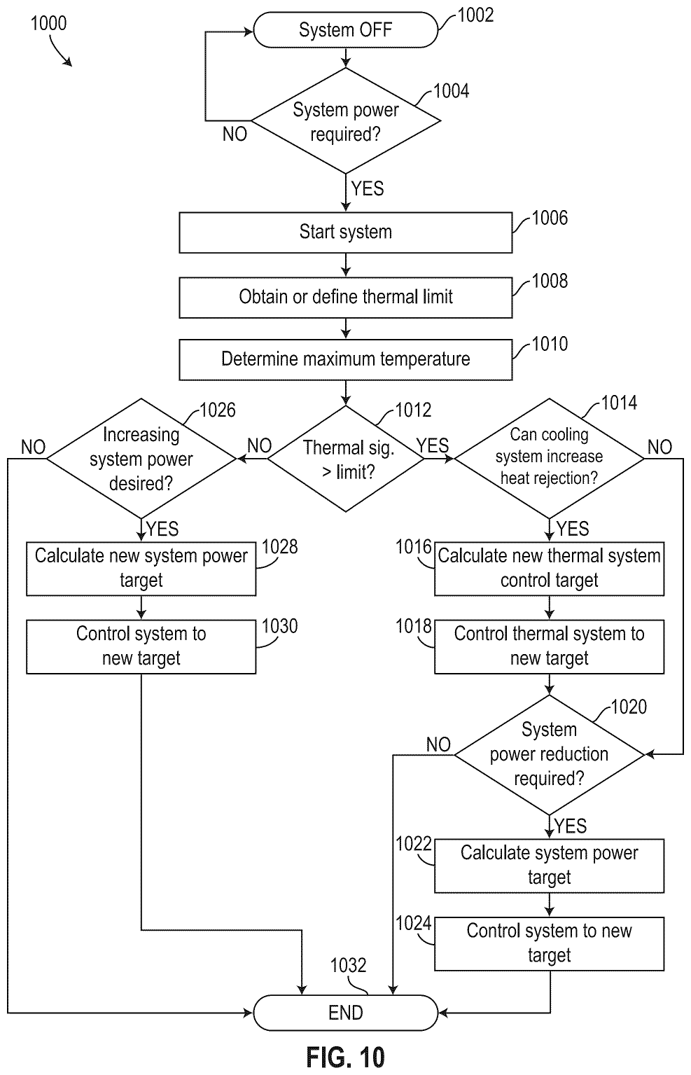

Referring to FIG. 10, a flow diagram of a process 1000 for operating the vehicle 10 (e.g., the fuel cell 14 and the fuel cell TMS 200) according to the thermal signature control mode 118 includes steps 1002-1032, according to some embodiments. The process 1000 may be performed by the controller 102 when operating according to the thermal signature control mode 118.

The process 1000 starts at step 1002 (system off), and includes determining if system power is required (step 1004), according to some embodiments. In some embodiments, determining if system power is required includes determining if the fuel cell 14 is required to provide power for the battery 16. If system power is required (step 1004, “YES”), process 1000 proceeds to step 1006. If system power is not required (step 1004, “NO”), process 1000 returns to step 1002 and maintains the system off.

The process 1000 includes starting the system (step 1006), obtaining or defining a thermal limit (step 1008), and determining a maximum temperature of the vehicle 10 (step 1010), according to some embodiments. In some embodiments, the thermal limit is a user defined value. In some embodiments, the thermal limit is determined based on sensors and data. For example, the thermal limit may be determined based on the ambient temperature obtained by the temperature sensor 216. In some embodiments, step 1008 includes identifying a maximum thermal signature that is allowed. In some embodiments, step 1010 includes obtaining temperature readings from multiple temperature sensors of the vehicle 10 (e.g., from multiple temperature sensors 212) and identifying a maximum or greatest value of all of the multiple temperature readings of the vehicle 10. In particular, the maximum temperature of the vehicle 10 may be a maximum value of all thermal signature readings of the vehicle 10.

The process 1000 includes determining if the thermal signature (e.g., the maximum temperature) exceeds the thermal limit (step 1012), according to some embodiments. Step 1012 may also include determining a thermal delta which is a difference between the maximum temperature and the thermal limit. In response to the thermal signature exceeding the thermal limit (step 1012, “YES”), process 1000 proceeds to step 1014. In response to the thermal signature being less than the thermal limit (step 1012, “NO”), process 1000 proceeds to step 1026.

The process 1000 includes determining if an increase of system power is desired (step 1026), according to some embodiments. In some embodiments, step 1026 includes identifying if the battery 16 requires additional energy. If an increase in system power is desired or required (step 1026, “YES”), process 1000 proceeds to step 1028. If an increase in system power is not desired or required (step 1026, “NO”), process 1000 proceeds to step 1032 and ends the process 1000.

The process 1000 includes calculating a new system power target (step 1028) and controlling the system to the new system power target (step 1030) in response to both the thermal signature being less than the thermal limit (step 1012, “NO”) and an increase in system power desired (step 1026, “YES”), according to some embodiments. In some embodiments, the new system power target is determined using a lookup table to calculate a new power target based on the thermal delta as determined in step 1012.

The process 1000 includes determining if the cooling system can increase heat rejection (step 1014), according to some embodiments. In some embodiments, step 1014 is performed in response to determining that the thermal signature exceeds the thermal limit (step 1012, “YES”). If the cooling system can increase heat rejection (step 1014, “YES”), process 1000 proceeds to step 1016. If the cooling system can not increase heat rejection (step 1014, “NO”), process 1000 proceeds to step 1020. Steps 1014-1024 can be performed in order to reduce the thermal signature. Steps 1026-1030 can be performed to increase power output of the fuel cell 14.

The process 1000 includes calculating a new thermal system control target (step 1016) and controlling the thermal system to the new thermal system control target (step 1018), according to some embodiments. In some embodiments, steps 1016-1018 are performed in response to determining that the cooling system (e.g., the fuel cell TMS 200) can increase heat rejection of the fuel cell 14 (step 1014, “YES”). In some embodiments, the new thermal system control target is determined by using a lookup table in order to calculate the new thermal system control target.

The process 1000 includes determining if system power reduction is required (step 1020), according to some embodiments. In some embodiments, step 1020 is performed in response to performing step 1018. In some embodiments, step 1020 is performed in response to determining that the cooling system can not increase heat rejection of the fuel cell 14 (step 1014, “NO”). In some embodiments, step 1020 includes identifying if the fuel cell TMS 200 is capable of rejecting sufficient heat to stay below the thermal limit. If the fuel cell TMS 200 is not capable of rejecting a sufficient amount of heat to maintain the thermal signature below the thermal limit, then the process 1000 proceeds to step 1020 (step 1020, “YES”). If the fuel cell TMS 200 is capable of rejecting a sufficient amount of heat to maintain the thermal signature below the thermal limit, then the process 1000 ends at step 1032.

The process 1000 includes calculating a system power target (step 1022) and controlling the system to the new system power target (step 1024), according to some embodiments. In some embodiments, the system power target is determined by using a lookup table in order to calculate the system power target. In some embodiments, the lookup table is a heat rejection to system power reduction table that uses an input of the thermal delta (as determined in step 1012) and outputs a system power reduction (e.g., a reduction of the power of the fuel cell 14).

### Mission Mode

Referring to FIGS. 3 and 11-13, the controller 102 may operate according to the mission mode 122, according to some embodiments. In some embodiments, the mission mode 122 facilitates communications between different vehicles or assets in an area that form a mesh network such that the vehicles or assets in the area may communicate with each other to facilitate operations of the mission mode 122 implemented at one or more of the vehicles or assets. For example, unmanned vehicles do not have a human operator on-board to detect threats and manually initiate mode changes of systems that may create thermal and/or acoustic signatures. In addition, there is an increased demand in hostile environments to both monitor and control new technology. Advantageously, the mission mode 122 facilitates performance of fuel cell vehicles and assets by enabling the ability to automatically switch between control modes based on assessed threats. If a threat is detected in the proximity or vicinity of the vehicle 10, the mission mode 122 facilitates automatically transitioning into a mode that reduces thermal and/or acoustic signature of the vehicle 10. If the vehicle 10 is not in a potential threat area, the mission mode 122 facilitates transitioning into a mode that meets energetic or user defined requirements.

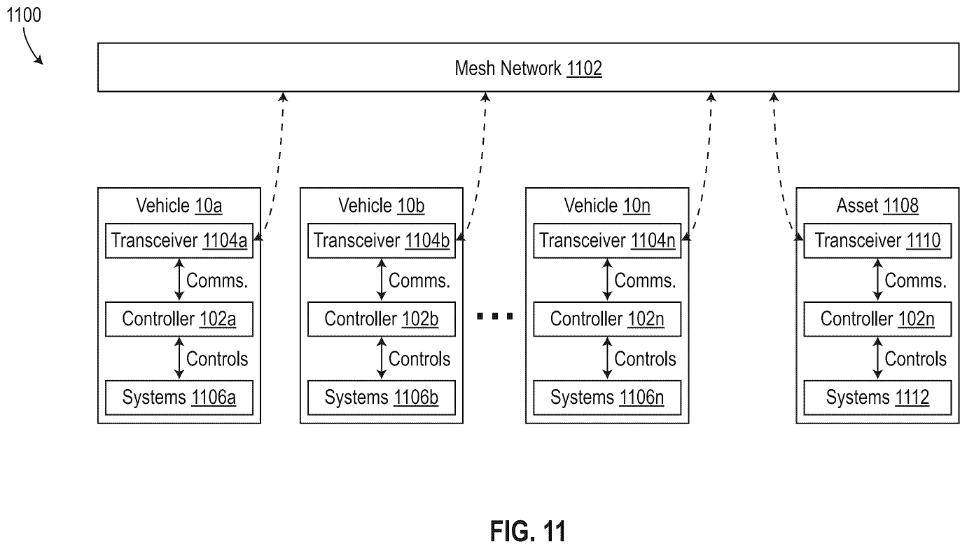

Referring particularly to FIG. 11, a block diagram 1100 illustrates system architecture of multiple vehicles 10 and one or more assets 1108 operating according to the mission mode 122. The system includes a mesh network 1102 that is defined between the vehicles 10 (e.g., vehicle 10a, 10b, . . . 10n) and optionally one or more assets 1108. In some embodiments, each of the vehicles 10 or assets 1108 include a corresponding transceiver 1104 that is configured to communicate wirelessly with the mesh network 1102. Similarly, the vehicles 10 or assets 1108 may include an implementation of the controller 102 configured to locally perform the mission mode 122. The vehicles 10 or assets 1108 may also each include one or more system 1106 (e.g., the control system 100, the fuel cell 14, the driveline 300, the weaponry 24, the accessories 26, the TMS 28, the ESS 12, the fuel cell TMS 200, etc.) that are configured to be operated according to different modes of operation (e.g., the acoustic signature control mode 116, the thermal signature control mode, the optimized efficiency mode 124, etc.). The systems 1106 may also include environmental detectors or sensors such as cameras, LIDAR sensors, radar, thermal imaging devices, a GPS, etc., such that the vehicles 10 and the assets 1108 can exchange identified environmental or threat detection data with each other as well as corresponding GPS location. In some embodiments, the mesh network 1102 facilitates communications between vehicles 10 that are out of range of direct communications with each other. In this way, one or more vehicles 10 or assets 1108 can function as relays and may forward packets of data between different vehicles 10 at geographic locations. In some embodiments, the mesh network 1102 is also configured to establish communications with a remote monitoring system or control system. One or more of the assets 1108 may include an aircraft, a drone, stationary sensors, satellites, etc. In some embodiments, the mesh network 1102 also facilitates radio or wireless communications for occupants of the vehicles 10 with occupants of other vehicles 10 or assets 1108. The assets 1108 may include satellite links, ground sensors, aircraft or airborne sensors, maritime or ocean sensors (e.g., sensors from ships or boats), etc.

In some embodiments, the controllers 102 include GPS boundaries that define areas having different threat levels. For example, different geographic areas may have a “low threat” level (e.g., a green zone), while other geographic areas may have a higher threat level (e.g., a red zone). In some embodiments, one or more geographic zones have unknown threat levels.

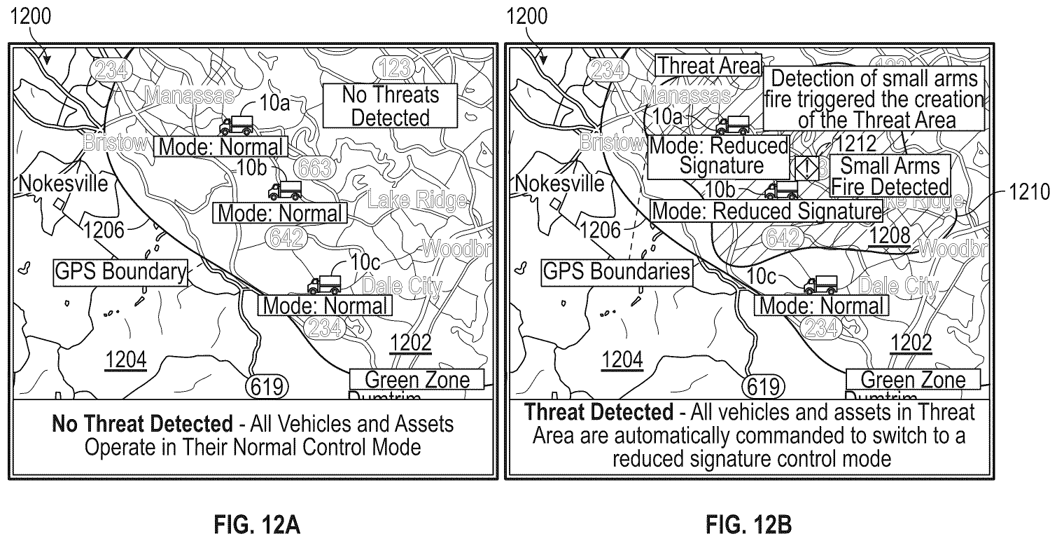

Referring to FIGS. 12A-12B, a map 1200 illustrates different zones, shown as unknown zone 1202 and green zone 1204. In some embodiments, the green zone 1204 indicates an area that is known to have a sufficient level of safety or lack of identified threats. In some embodiments, the unknown zone 1202 indicates a zone where no threats have been yet detected, but that cannot yet be confirmed as a green zone. The unknown zone 1202 and the green zone 1204 may be defined by a GPS boundary 1206. In some embodiments, the GPS boundaries that define different zones such as the green zone 1204 and the unknown zone 1202 are stored in a central command computer which is relayed to the controllers 102 of the vehicles 10. In some embodiments, the GPS boundaries that define the different zones are determined based on satellite data, data obtained from the vehicles 10 or assets 1108, aircraft data, data obtained from a drone, etc. In some embodiments, each of the controllers 102 of the vehicles 10 or the assets 1108 store the map 1200 (and the corresponding GPS boundaries and zones) locally in memory.

Referring particularly to FIG. 12A, three vehicles 10a, 10b, and 10c are shown positioned within the unknown zone 1202 where no threats have yet been detected. The controllers 102 of the vehicles 10 in the zone 1202 may be operated according to a normal mode of operation (e.g., the optimized efficiency mode 124 or a normal control mode) if no threats have been detected. In some embodiments, if threats are detected by one or more of the vehicles 10 or by one of the assets 1108, the controller 102 or the central command computer is configured to update a threat level of one or more of the zones, or generate a new zone. The vehicles 10 that implement the mission mode 122 can change between different modes based on the updates to the map 1200.

For example, as shown in FIG. 12B, a threat 1212 is identified proximate vehicle 10b. In some embodiments, the vehicles 10 are configured to identify both presence of a threat and type of the threat. In the example shown in FIG. 12B, the map 1200 is updated to include a new zone, shown as threat zone 1208 (e.g., a threat area). In some embodiments, the vehicles 10 that are within GPS boundaries 1210 of the threat zone 1208 are automatically commanded (e.g., by the mission mode 122 implemented on the controller 102) to transition into a reduced signature mode (e.g., one of the acoustic signature control mode 116, the thermal signature control mode 118, or the acoustic and thermal signature control mode 120). In some embodiments, which of the reduced signature modes that the vehicles 10 transition into is determined based on the type of the threat that is detected.

For example, if a threat is detected near a road that an unmanned logistics convoy is traveling along, the controller 102 of the unmanned logistics convoy vehicles (when operating in the mission mode 122) may automatically transition the vehicles in the logistics convoy into the acoustic and thermal signature control mode 120 in order to reduce a likelihood that the convoy vehicles are detected or targeted. Once the convoy vehicles exit the threat area, the controller 102 of the convoy vehicles may automatically transition into a different mode (e.g., the optimized efficiency mode 124, a normal operating mode, etc.) in order to recharge the batteries 16 of the convoy vehicles (e.g., to make up for any lost energy while in the acoustic and thermal signature control mode 120, the acoustic signature control mode 116, or the thermal signature control mode 118).

In another example, if a manned vehicle is on a mission or route from a safe or green area (e.g., a green zone) to engage a target in a threat area, the controller 102 of the manned vehicle may automatically transition into one of the acoustic signature control mode 116, the thermal signature control mode 118, or the acoustic and thermal signature control mode 120 in order to reduce a likelihood of detection of the vehicle. The vehicle may be maintained in a mode that keeps the battery 16 at 100% state of charge (SOC) while travelling in a green zone. Advantageously, this may provide the vehicle 10 and soldiers or occupants of the vehicle 10 with maximum available anergy at the battery 16 for when the vehicle arrives at the target or enters the threat area of the target (and also allow for longest operation of the vehicle using power from the batteries 16 only). Once the vehicle reaches the threat or hostile area (determined by the controller 102 based on GPS data of the vehicle and any mission modes data obtained via the mesh network 1102), the controller 102 of the vehicle may automatically transition into one of the reduced signature modes. The controller 102 may be configured to maintain the vehicle in the reduced signature mode until a user input or detected event occurs. The detected event may include traveling into a green area or low threat area. The detected event may also include detection of continuous shots or weaponry operation (e.g., of the weaponry of the vehicle or of hostile weaponry), detection of a missile being fired by an enemy, etc. The detected event can be identified by the controller 102 based on sensor data from one or more systems of the vehicle such as radar systems, LIDAR systems, thermal image systems, image data, neural network or machine learning techniques to identify that the vehicle has been detected by an enemy, etc. Once the detected event has occurred, the controller 102 may transition into a mode in order to rapidly charge the batteries 16. In some embodiments, which of the modes the controller 102 transitions between responsive to threat level of a current zone is a user programmable setting or set by a system administrator.

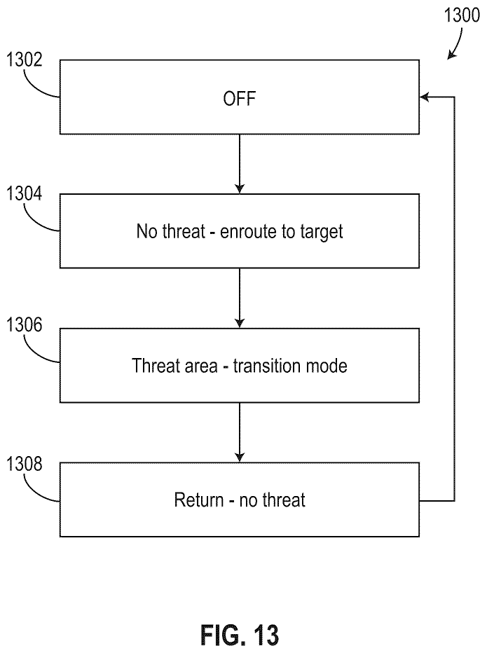

Referring to FIG. 13, a state transition diagram 1300 illustrates operation of the vehicle 10 according to the mission mode 122. The state transition diagram 1300 includes states 1302-1308, according to some embodiments. It should be understood that the state diagram 1300 1300 described herein with reference to FIG. 13 is intended for example purposes only, illustrating a potential course of mode transitions that could occur due to detection of threats.

The state diagram 1300 begins at an off state (state 1302), and proceeds to maintaining the control mode in a normal mode (state 1304) when no threats are detected and the vehicle 10 is enroute to a target. At state 1304, the vehicle 10 may be enroute to a target location without any detected threats. When threats are not detected, and the vehicle 10 is not in a threat or high alert area or zone, the controller 102 may operate the vehicle 10 according to a mode such that the battery 16 is maintained at 100% SOC.

In response to moving into a threat area or detecting a threat, the controller 102 may transition the vehicle 10 into a reduced signature mode (state 1306), according to some embodiments. In some embodiments, the reduced signature mode is one of the acoustic signature control mode 116, the thermal signature control mode 118, or the acoustic and thermal signature control mode 120. In response to moving out of the threat area or identifying that the threat is no longer active, the controller 102 transitions into the state 1308. In the state 1308, the controller 102 transitions back into a normal operating mode to charge the battery 16.

Advantageously, the mission mode 122 described herein with reference to FIGS. 11-13 can be implemented to automatically transition the vehicle 10 between different modes of operation based on assessed threat level, without requiring user or operator input. The automatic transitioning of the vehicle 10 between the different modes can facilitate removing the need for the operator to manually change control modes, and reduces cognitive load on the drivers or operators. For unmanned vehicles and systems, the mission mode 122 facilitates intelligent use of a range of control modes including signature control modes. In some embodiments, during implementation of the mission mode 122, the controller 102 is configured to implement any of the techniques as described in greater detail in U.S. application Ser. No. 17/886,610, filed Aug. 12, 2022, the entire disclosure of which is incorporated by reference herein.

### Optimized Efficiency Mode

Referring to FIGS. 3 and 14-16, the controller 102 may implement the optimized efficiency mode 124 in order to improve overall efficiency of the vehicle 10 or a hybrid electric system. In some embodiments, the optimized efficiency mode 124 is performed in order to calculate one or more operating points (e.g., power output of the fuel cell 14 or a generator set (genset)) that yield a lowest or reduced energy loss to output ratio. In some embodiments, the energy loss to output ratio is used to limit operation of the vehicle 10 (e.g., the fuel cell 14, the fuel cell TMS 200, etc.) to conditions that provide highest efficiency. The optimized efficiency mode 124 is performed in order to consider efficiency of the vehicle 10 or the fuel cell TMS 200 at a system level instead of at a component level. Advantageously, the optimized efficiency mode 124 is configured to determine best or optimal overall operating points by running a sweep or prediction of multiple operating points. In some embodiments, the optimized efficiency mode 124 uses a predictive efficiency calculation in order to limit operation of the vehicle 10, the fuel cell 14 (or a genset), and/or the fuel cell TMS 200 that are at or above a threshold efficiency. In particular, the optimized efficiency mode 124 can improve overall efficiency of the vehicle 10 while still meeting user defined requirements for the vehicle 10 (e.g., required power output of the battery 16). The optimized efficiency mode 124 may be particularly advantageous for multi-day outdoor operations of the vehicle 10 where the optimized efficiency mode 124 can take advantage of efficiency gains at lower ambient temperatures during the night time, increased wind, etc., to charge the battery 16. The optimized efficiency mode 124 may limit operation of the vehicle 10, the fuel cell 14 (or genset), and/or the fuel cell TMS 200 during the day where most energy is lost due to thermal systems of the vehicle 10 (e.g., the fuel cell TMS 200).

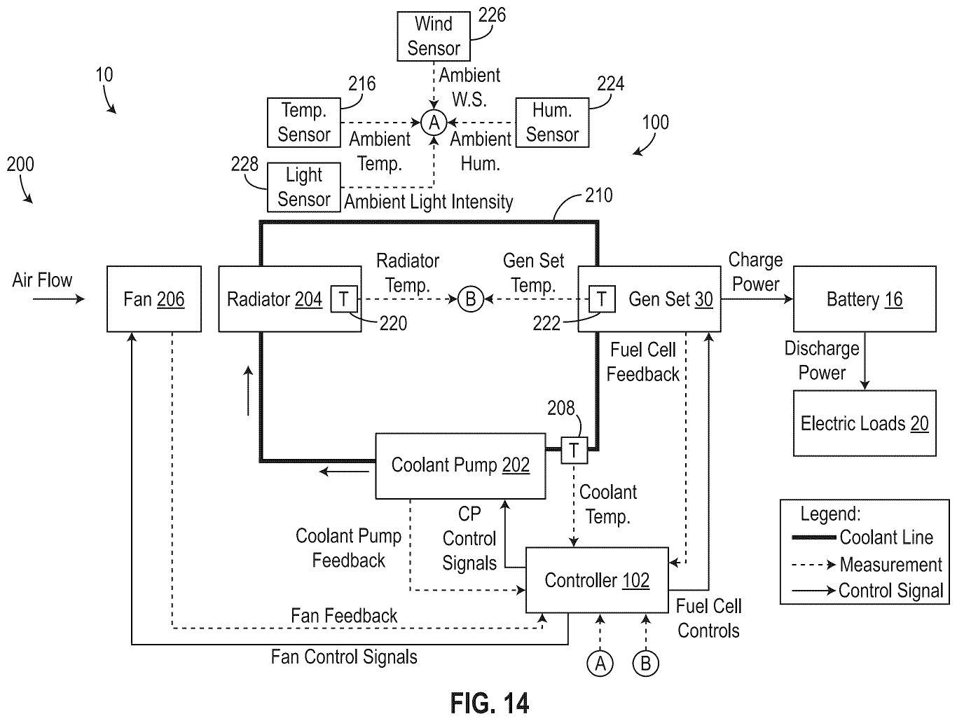

Referring particularly to FIG. 14, the controller 102 is shown implementing the optimized efficiency mode 124 for the vehicle 10 including a genset 30 in place of the fuel cell 14. In some embodiments, the fuel cell TMS 200 for the genset 30 is the same as or similar to the fuel cell TMS 200 for the fuel cell 14. It should be understood that while FIG. 14 and the description of the optimized efficiency mode 124 as described herein are described with reference to the genset 30, the optimized efficiency mode 124 can also be performed for the fuel cell 14 or any hybrid electric vehicle. The optimized efficiency mode 124 may be implemented in order to minimize energy consumption of the vehicle 10 or systems of the vehicle 10 by utilizing environmental conditions. For example, the optimized efficiency mode 124 may be implemented in order to achieve as many functions as possible without using the fan 206. The optimized efficiency mode 124 may take advantage of cooler ambient temperature to charge the battery 16 while limiting use of the fuel cell 14 or the genset 30 when ambient temperatures are warmer. The optimized efficiency mode 124 can also take into account efficiency of the fuel cell 14, the battery 16, the genset 30, the fuel cell TMS 200, etc., based on impacts to the efficiency due to humidity, effects of solar loading, or other environmental or ambient conditions.

The fuel cell TMS 200 includes the temperature sensor 216 configured to measure and provide the ambient temperature, and also includes a humidity sensor 224 that is configured to measure the ambient humidity around or proximate the vehicle 10. The humidity sensor 224 is configured to provide the ambient humidity to the controller 102 for use in determining the controls for the coolant pump 202, the fan 206, and the genset 30 (or the fuel cell 14) according to the optimized efficiency mode 124. In some embodiments, the fuel cell TMS 200 also includes a wind sensor 226 configured to measure and provide the ambient wind speed to the controller 102. In some embodiments, the fuel cell TMS 200 also includes a light sensor 228 configured to measure and provide the ambient light intensity to the controller 102. The controller 102 is configured to generate the controls for the vehicle 10, the fuel cell TMS 200, or components of the vehicle 10 or the fuel cell TMS 200 using the ambient windspeed, the ambient humidity, the ambient light intensity, and the ambient temperature. The fuel cell TMS 200 also includes the temperature sensor 222 configured to measure a temperature of the genset 30.

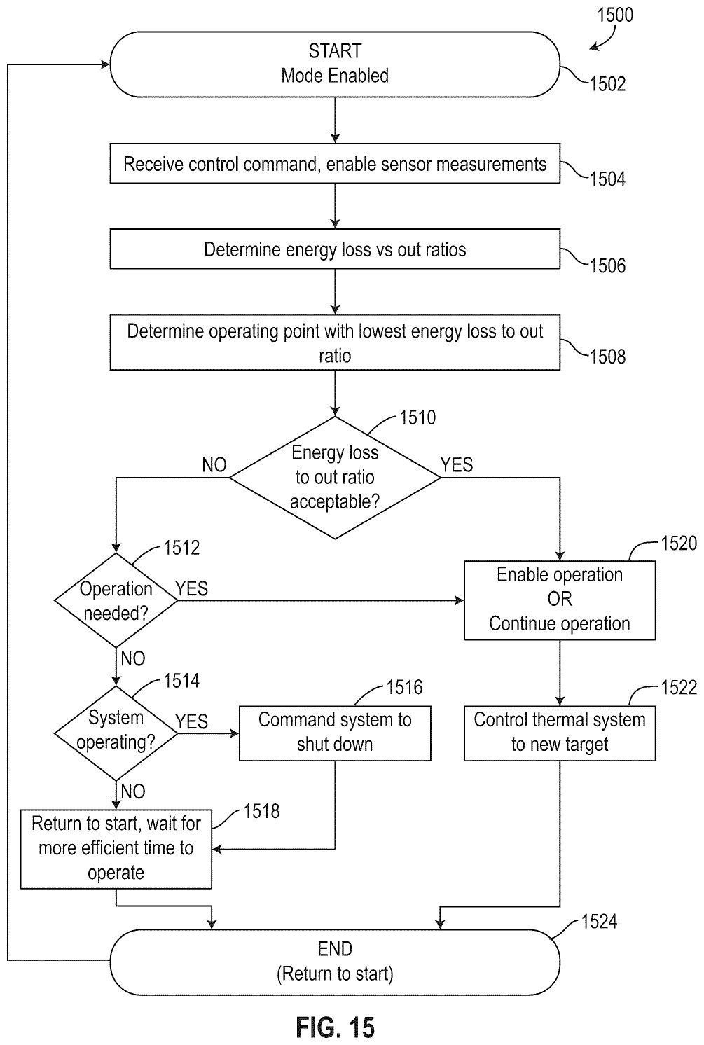

Referring to FIG. 15, a flow diagram of a process 1500 for operating the vehicle 10 according to the optimized efficiency mode 124 includes steps 1502-1524, according to some embodiments. In some embodiments, the process 1500 is performed by the controller 102 in order to operate the fan 206, the coolant pump 202, and the genset 30 or the fuel cell 14 according to the optimized efficiency mode 124.

The process 1500 includes starting and enabling the optimized efficiency mode 124 (step 1502), according to some embodiments. In some embodiments, the optimized efficiency mode 124 is enabled by receiving a user input. The process 1500 includes receiving a control command and enabling sensor measurements (step 1504), according to some embodiments. The control command may be a command to operate or transport the vehicle 10 and may require a power output of the battery 16. The sensor measurements may include any of the sensor data obtained by the controller 102 as shown in FIG. 14.

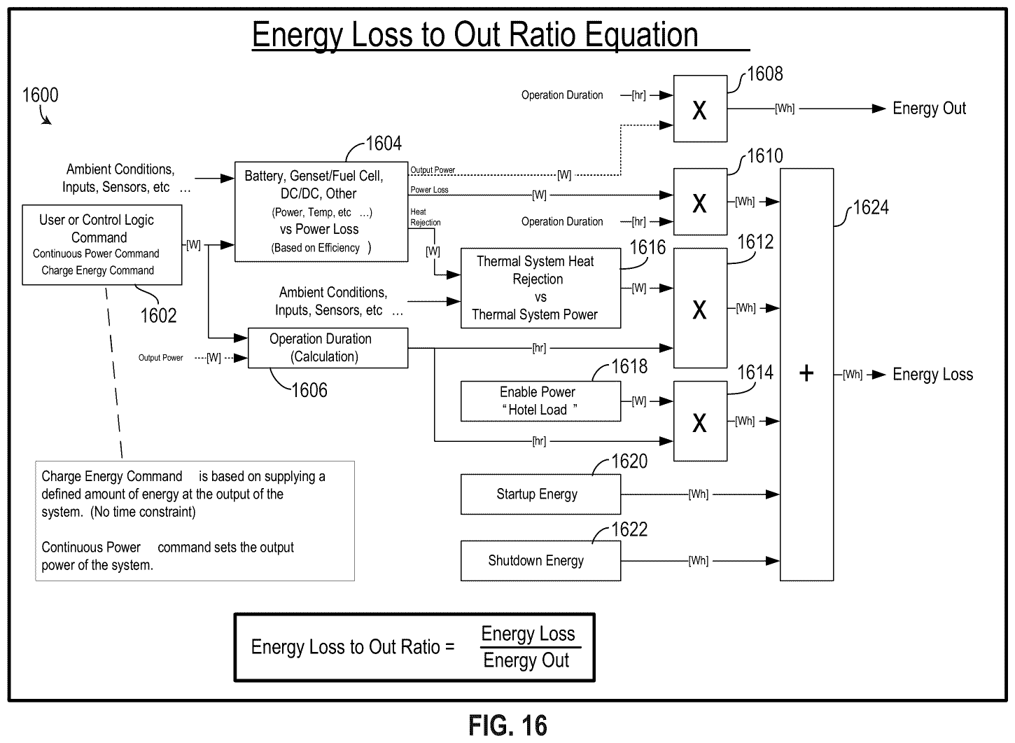

The process 1500 also includes determining energy loss versus out ratios based on multiple fuel cell power setpoints (step 1506), according to some embodiments. In some embodiments, step 1506 includes generating an array of fuel cell or genset power setpoints (e.g., power output by the fuel cell 14 or the genset 30 to the battery 16) and determining the energy loss versus out ratio for each. The energy loss versus out ratio may be determined using the techniques as described in greater detail below with reference to FIG. 16. In some embodiments, the fuel cell power setpoints are generated by the controller 102 using an algorithm. For example, the power setpoints for the fuel cell or the genset may include multiple power setpoints that span a range (e.g., from a low threshold to a high threshold). In some embodiments, step 1506 includes predicting or simulating the energy loss versus output ratios for each of the proposed power setpoints using a model or a predictive technique. For example, step 1506 may include generating an array of possible power setpoints: P=[P₁, P₂, P₃, . . . Pₙ], and determining corresponding energy loss versus out ratios for each of the power setpoints: R=[R₁, R₂, R₃, . . . , Rₙ].

The process 1500 includes determining an operating point with a lowest energy loss to out ratio (step 1508), according to some embodiments. For example, step 1508 may include selecting a minimum (e.g., an ith ratio) of the ratios, Rᵢ, and a corresponding power setpoint Pᵢ from the array of possible power setpoints. The process 1500 includes determining if the energy loss to out ratio is acceptable (step 1510), according to some embodiments. In some embodiments, step 1510 includes determining if the energy loss to out ratio selected in step 1508 meets a threshold ratio value. In some embodiments, step 1510 includes determining if the energy loss to out ratio selected in step 1508 has a sufficient amount of power export from the fuel cell 14 or the genset 30 required to perform a requested control command. If the energy loss to out ratio selected in step 1508 is acceptable (step 1510, “YES”), process 1500 proceeds to step 1520 at which point operation of the fuel cell 14 or the genset 30 is activated (step 1520) and the fuel cell 14 or the genset 30 are operated according to the power setpoint corresponding to the ratio selected in step 1508. Step 1522 may also include operating the fuel cell TMS 200 to provide sufficient thermal control.

In response to the energy loss to out ratio not being acceptable (step 1510, “NO”), process 15009 proceeds to step 1512. Step 1512 includes determining if operation of the fuel cell 14 or the genset 30 is needed. Step 1512 may be performed by comparing a current SOC of the battery 16 to a threshold, and determining that the battery 16 needs to be charged if the current SOC is less than the threshold. In response to determining that the battery 16 needs to be charged (step 1512, “YES”), process 1500 proceeds to step 1520. In response to determining that the battery 16 does not require charging (step 1512, “NO”), process 1500 proceeds to step 1514.

The process 1500 includes determining if the system is operating (step 1514), according to some embodiments. In some embodiments, step 1514 includes determining if the fuel cell 14 or the genset 30 are providing power to the battery 16. In response to identification that the system is operating (step 1514, “YES”), process 1500 proceeds to step 1516 at which point operation of the fuel cell 14 or the genset 30 is shut off (step 1516), and process 1500 then proceeds to step 1518 after step 1516. In response to determining that the system is not operating (step 1514, “NO”), process 1500 proceeds to step 1518.

The process 1500 includes returning to the step 1502 (step 1518) and waiting for a more efficient time to operate the fuel cell 14 or the genset 30 (and the corresponding fuel cell TMS 200), according to some embodiments. In this way, the fuel cell 14 or the genset 30, and the corresponding thermal system fuel cell TMS 200 are activated and used when it is necessary to charge the battery 14, and when it is most optimal to do so.

Referring to FIG. 16, diagram 1600 illustrates calculation of the energy loss to out ratio, according to some embodiments. The energy loss to out ratio, R, may generally be calculated using the equation

$$R = \frac{Energy Loss}{Energy Out}$$

where the energy loss is lost energy of the vehicle 10 for proposed power setpoints or more specifically by the fuel cell 14, the genset 30, and/or the fuel cell TMS 200, and the energy out indicates energy output of the battery 16, genset 30, fuel cell 14, a DC-DC converter, etc., or any other power source.

The diagram 1600 includes a power model 1604 that receives the ambient sensor data (e.g., the ambient wind speed, the ambient temperature, the ambient humidity, the ambient light intensity, etc.), as well as a user or logic command 1602. The user or logic command 1602 may be a continuous power command or a charge energy command. In some embodiments, the charge energy command is based on supplying a defined amount of energy at an output of the system (e.g., the ESS 12, the fuel cell 14, the genset 30, etc.). In some embodiments, the charge energy command does not have a time constraint. In some embodiments, the continuous power command sets an output power for the system that is to be continuously achieved over time. The power model 1604 is configured to receive the user or control logic command (e.g., in Watts or Kilowatts), as well as the ambient conditions, or any other sensor data or inputs, and predict (i) an output power of the system (e.g., output power of the ESS 12), a power loss of the system, and a heat rejection of the system (e.g., heat rejection of the fuel cell TMS 200). In some embodiments, the power loss of the system determined by the power model 1604 is a power loss due to discharge of the battery 16 or the ESS 12 and is determined based on estimated efficiency of the ESS 12. In some embodiments, the power loss, the heat rejection, and the output power that are estimated by the power model 1604 all have units of Watts or Kilowatts. The output power and the power loss may be determined based on power, temperature, etc. In some embodiments, the power model 1604 is a transfer function, a multi-dimensional graph, a lookup table, a set of equations, etc., configured to predict or output the output power, the power loss, and the heat rejection based on the inputs.

The diagram 1600 also includes a duration calculator 1606 that is configured to receive the user or control logic command 1602, and the output power from the power model 1604. The duration calculator is configured to predict, calculate, or estimate, a duration of operation of the ESS 12 at the output power, and output the duration of operation (in hours or any other unit of time) to a first multiplication block 1608, a second multiplication block 1610, a third multiplication block 1612, and a fourth multiplication block 1614 (e.g., multipliers).

The first multiplication block 1608 is configured to predict energy out (e.g., total energy output) of the system (e.g., the ESS 12, the fuel cell 14, the battery 16, the genset 30, etc.). In some embodiments, the multiplication block 1608 receives the output power from the power model 1604 and the duration of operation from the duration calculator 1606 and multiplies the duration of operation with the output power in order to determine the energy out in Kilowatt-hours or Watt-hours.

The second multiplication block 1610 is configured to receive the power loss from the power model 1604 and the duration of operation from the duration calculator 1606 and determine a first energy loss amount. In some embodiments, the second multiplication block 1610 multiplies the power loss from the power model 1604 with the duration of operation to determine the first energy loss amount. The first energy loss amount may be expressed in terms of Watt Hours or Kilowatt Hours and represents an amount of energy lost due to inherent inefficiencies in the system modeled by the power model 1604.

The diagram 1600 includes a thermal system power estimator 1616 that is configured to receive the heat rejection from the power model 1604 (e.g., the required heat rejection for the corresponding power output and operating conditions of the fuel cell 14 or the genset 30) and estimate an amount of power that is predicted to be consumed by the fuel cell TMS 200 in order to achieve the heat rejection as output by the power model 1604. In some embodiments, the thermal system power estimator 1616 is configured to predict power consumption of the coolant pump 202, the genset 30 or the fuel cell 14, and the fan 206 in order to achieve the required heat rejection given current ambient conditions (e.g., the sensor data provided by the humidity sensor 224, the wind sensor 226, the temperature sensor 216, and/or the light sensor 228). In some embodiments, the thermal system power estimator 1616 is configured to output the thermal system power to the third multiplication block 1612. The third multiplication block 1612 is configured to receive the power consumption of the fuel cell TMS 200 (e.g., the thermal system power) in order to achieve heat rejection, and multiply the thermal system power by the duration that is provided by the duration calculator 1606. The third multiplication block 1612 outputs a second energy loss amount (e.g., in Watt-hours or Kilowatt-hours) corresponding to energy losses associated with operating the fuel cell TMS 200. The first energy loss amount and the second energy loss amount are provided as inputs to an energy loss estimator 1624.

The diagram 1600 also includes a fourth multiplication block 1614 that receives an enable power 1618 and also receives the duration of operation from the duration calculator 1606. The enable power 1618 may represent miscellaneous or “hotel loads” such as lighting, communications power loads, weaponry 24, accessories 26, TMS 28, heating and cooling systems, etc. In some embodiments, the fourth multiplication block 1614 is configured to determine a third energy loss amount by multiplying the enable power 1618 with the duration of operation, and provide the third energy loss amount to the energy loss estimator 1624.

The energy loss estimator 1624 is also configured to receive a fourth energy loss amount, shown as startup energy 1620, and a fifth energy loss amount, shown as shutdown energy 1622. The startup energy 1620 indicates an amount of energy required to start the fuel cell TMS 200, the fuel cell 14, and/or the genset 30. The shutdown energy 1622 indicates an amount of energy required to shut down the fuel cell TMS 200, the fuel cell 14, and/or the genset 30. The energy loss estimator 1624 is configured to add the first energy loss amount provided by the second multiplication block 1610, the second energy loss amount provided by the third multiplication block 1612, the third energy loss amount provided by the fourth multiplication block 1614, the fourth energy loss amount (e.g., the startup energy 1620), and the fifth energy loss amount (e.g., the shutdown energy 1622) in order to determine a total energy loss, shown as energy loss. The energy loss determined by the energy loss estimator 1624, and the energy out (e.g., energy output) determined by the first multiplication block 1608 can be used in order to determine the energy loss to out ratio, R. In some embodiments, any of the functionality described herein with reference to FIG. 16 are performed by the controller 102. In some embodiments, any of the functionality described herein with reference to FIG. 16 is performed in step 1506 for multiple different power setpoints for the fuel cell 14 or the genset 30 as described in greater detail above with reference to FIG. 15.

### Overall Process

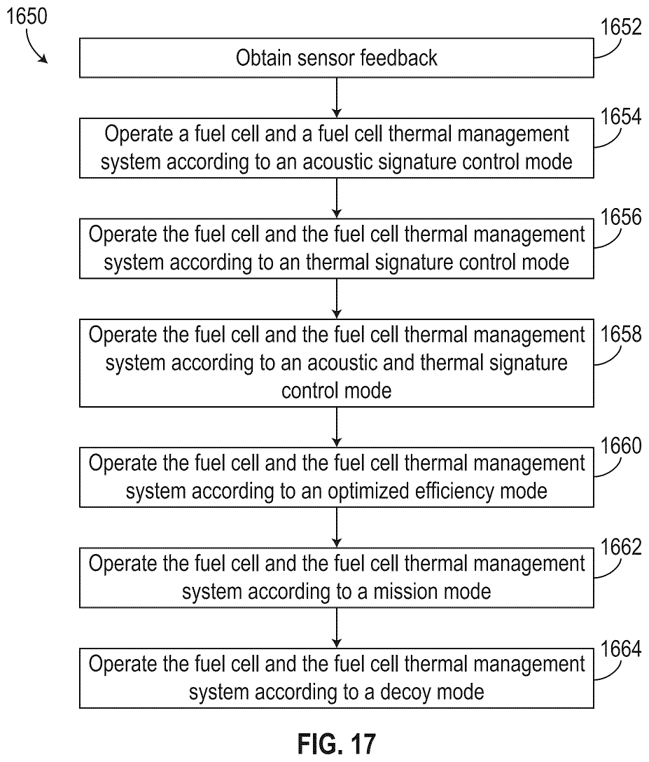

Referring to FIG. 17, a flow diagram of a process 1650 for operating the vehicle 10 (e.g., the fuel cell 14 and the fuel cell TMS 200) includes steps 1652-1664. The process 1650 can be performed by the fuel cell TMS 200. The process 1650 includes obtaining sensor feedback (step 1652), according to some embodiments. The sensor feedback can include sensor feedback from the wind sensor 226, the temperature sensor 216, the humidity sensor 224, the light sensor 228, the fan feedback, the coolant pump feedback, the fuel cell feedback, the coolant temperature from the temperature sensor 208, the radiator temperature from the temperature sensor 220, and/or the gen set temperature obtained from the temperature sensor 222.

The process 1650 also includes operating a fuel cell and a fuel cell thermal management system according to an acoustic signature control mode (step 1654), according to some embodiments. The step 1654 can include operating the fuel cell 14 and the fuel cell TMS 200 according to the acoustic signature control mode as described in greater detail above with reference to FIGS. 4-6. The process 1650 also operating the fuel cell and the fuel cell TMS according to the thermal signature control mode (step 1656), according to some embodiments. The step 1656 can include operating the fuel cell 14 and the fuel cell TMS 200 according to the thermal signature control mode as described in greater detail above with reference to FIGS. 9-10.

The process 1650 also includes operating the fuel cell and the fuel cell TMS according to an acoustic and thermal signature control mode (step 1658), according to some embodiments. In some embodiments, step 1658 includes operating the fuel cell 14 and the fuel cell TMS 200 according to the thermal and acoustic signature control mode as described in greater detail above with reference to FIGS. 7-8. The process 1650 includes operating the fuel cell and the fuel cell TMS according to an optimized efficiency mode (step 1660), according to some embodiments. In some embodiments, step 1660 includes operating the fuel cell 14 and the fuel cell TMS 200 according to the optimized efficiency mode as described in greater detail above with reference to FIGS. 3 and 14-16.

The process 1650 also includes operating the fuel cell and the fuel cell TMS according to a mission mode (step 1662), according to some embodiments. In some embodiments, step 1662 includes operating the fuel cell 14 and the fuel cell TMS 200 according to the mission mode as described in greater detail above with reference to FIGS. 3 and 11-13. The process 1650 also includes operating the fuel cell and the fuel cell TMS according to a decoy mode (step 1664), according to some embodiments. In some embodiments, operating the fuel cell 14 and the fuel cell TMS 200 according to the decoy mode is similar to operating the fuel cell 14 and the fuel cell TMS 200 according to the acoustic and thermal signature control mode, and includes adjusting (e.g., increasing) the acoustic or thermal signature to match environmental temperature and acoustic characteristics. For example, the step 1664 can include operating the fuel cell 14 and the fuel cell TMS 200 according to a decoy mode in which at least one of the acoustic signature or the thermal signature are increased to a decoy level.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

1. A vehicle, comprising:
a battery configured to supply energy to a plurality of loads;
an electric motor configured to receive energy from the battery;
a fuel cell;
a fuel cell thermal management system (TMS) comprising a fan, a pump, and a heat exchanger, the fuel cell TMS configured to provide heating or cooling to the fuel cell; and
processing circuitry, configured to:
operate the fuel cell and the fuel cell TMS according to an acoustic signature control mode in which an acoustic signature of the vehicle is adjusted towards a target acoustic signature level;
operate the fuel cell and the fuel cell TMS according to a thermal signature control mode in which a thermal signature of the vehicle is adjusted towards a target thermal signature level;
operate the fuel cell and the fuel cell TMS according to an acoustic and thermal signature control mode in which both the acoustic signature is adjusted towards the target acoustic signature level and the thermal signature of the vehicle is adjusted towards the target thermal signature level;
operate the fuel cell and the fuel cell TMS according to an optimized efficiency mode in which the processing circuitry adjusts operation of the fuel cell and the fuel cell TMS based on ambient conditions to reduce energy losses of the fuel cell, the fuel cell TMS, and the battery; and
operate the fuel cell and the fuel cell TMS according to a mission mode in which the processing circuitry automatically transitions between at least the acoustic signature control mode, the thermal signature control mode, the acoustic and thermal signature control mode, and the optimized efficiency mode based on mission data obtained from a mesh network of vehicles.

2. The vehicle of claim 1, wherein in the acoustic signature control mode, the processing circuitry is configured to estimate the acoustic signature of the vehicle based on estimated noise output of the fan, the pump, and the fuel cell, and adjust operation of the fan, the pump, and the fuel cell to drive the acoustic signature towards the target acoustic signature level.

3. The vehicle of claim 1, wherein in the thermal signature control mode, the processing circuitry is configured to obtain thermal signature data of the thermal signature of the vehicle from a first temperature sensor and ambient temperature data from a second temperature sensor, and operate the fan, the pump, and the fuel cell to drive the thermal signature of the vehicle towards the target thermal signature level.

4. The vehicle of claim 1, wherein in the acoustic and thermal signature control mode, the processing circuitry is configured to obtain thermal signature data of the thermal signature of the vehicle from a temperature sensor and acoustic signature data of the acoustic signature of the vehicle from an acoustic sensor, and operate the fan, the pump, and the fuel cell to maintain both the thermal signature of the vehicle at the target thermal signature level and the acoustic signature of the vehicle at the target acoustic signature level.

5. The vehicle of claim 1, wherein in the optimized efficiency mode, the processing circuitry is configured to obtain ambient temperature, humidity, windspeed, and light intensity data, and control the fuel cell and the fuel cell TMS based on the ambient temperature, humidity, windspeed, and light intensity data to optimize an energy efficiency of the fuel cell and the fuel cell TMS for current ambient conditions.

6. The vehicle of claim 1, wherein the fuel cell is configured to operate to provide energy to the battery.

7. The vehicle of claim 1, wherein the processing circuitry is further configured to:
operate the fuel cell and the fuel cell TMS according to a decoy mode in which at least one of the acoustic signature or the thermal signature are increased to a decoy level.

8. The vehicle of claim 1, wherein the processing circuitry is configured to operate the fuel cell and the fuel cell TMS to heat water of a sanitization system to sanitize the water.

9. A system for a vehicle, the system comprising:
a fuel cell;
a fuel cell thermal management system (TMS) configured to provide heating or cooling to the fuel cell; and
processing circuitry configured to operate the fuel cell and the fuel cell TMS such that an acoustic signature or thermal signature of the vehicle is controlled to a target acoustic signature level or a target thermal signature level.

10. The system of claim 9, wherein the processing circuitry is configured to:
operate the fuel cell and the fuel cell TMS according to an optimized efficiency mode in which the processing circuitry adjusts operation of the fuel cell and the fuel cell TMS based on ambient conditions to reduce energy losses of the fuel cell, the fuel cell TMS, and a battery.

11. The system of claim 9, wherein the processing circuitry is configured to:
operate the fuel cell and the fuel cell TMS according to a mission mode in which the processing circuitry automatically transitions between at least an acoustic signature control mode in which the acoustic signature of the vehicle is adjusted towards the target acoustic signature level, a thermal signature control mode in which the thermal signature of the vehicle is adjusted towards the target thermal signature level, an acoustic and thermal signature control mode in which both the acoustic signature is adjusted towards the target acoustic signature level and the thermal signature of the vehicle is adjusted towards the target thermal signature level, and an optimized efficiency mode in which the processing circuitry adjusts operation of the fuel cell and the fuel cell TMS based on ambient conditions to reduce energy losses of the fuel cell, the fuel cell TMS, and a battery.

12. The system of claim 9, wherein the processing circuitry is configured to estimate the acoustic signature of the vehicle based on estimated noise output of a fan, a pump, and the fuel cell, and adjust operation of the fan, the pump, and the fuel cell to drive the acoustic signature towards the target acoustic signature level.

13. The system of claim 9, wherein the processing circuitry is configured to obtain thermal signature data of the thermal signature of the vehicle from a first temperature sensor and ambient temperature data from a second temperature sensor, and operate a fan, a pump, and the fuel cell to drive the thermal signature of the vehicle towards the target thermal signature level.

14. The system of claim 9, wherein the processing circuitry is configured to obtain thermal signature data of the thermal signature of the vehicle from a temperature sensor and acoustic signature data of the acoustic signature of the vehicle from an acoustic sensor, and operate a fan, a pump, and the fuel cell to maintain both the thermal signature of the vehicle at the target thermal signature level and the acoustic signature of the vehicle at the target acoustic signature level.

15. The system of claim 9, wherein the fuel cell is configured to operate to provide energy to a battery.

16. The system of claim 9, wherein the processing circuitry is configured to operate the fuel cell and the fuel cell TMS to heat water of a sanitization system to sanitize the water.

17. The system of claim 9, wherein the processing circuitry is configured to operate the fuel cell and the fuel cell TMS according to a decoy mode in which at least one of the acoustic signature or the thermal signature are increased to a decoy level.

18. A method of controlling a fuel cell system of a vehicle, the method comprising:
obtaining feedback from a sensor of the fuel cell system;
operating a fuel cell and a fuel cell thermal management system (TMS) based on the feedback according to an acoustic signature control mode in which an acoustic signature of the vehicle is adjusted towards a target acoustic signature level;
operating the fuel cell and the fuel cell TMS based on the feedback according to a thermal signature control mode in which a thermal signature of the vehicle is adjusted towards a target thermal signature level;
operating the fuel cell and the fuel cell TMS based on the feedback according to an acoustic and thermal signature control mode in which both the acoustic signature is adjusted towards the target acoustic signature level and the thermal signature of the vehicle is adjusted towards the target thermal signature level;
operating the fuel cell and the fuel cell TMS based on the feedback according to an optimized efficiency mode in which operation of the fuel cell and the fuel cell TMS is adjusted based on ambient conditions to reduce energy losses of the fuel cell, the fuel cell TMS, and a battery; and
operating the fuel cell and the fuel cell TMS based on the feedback according to a mission mode in which the vehicle is automatically transitioned between at least the acoustic signature control mode, the thermal signature control mode, the acoustic and thermal signature control mode, and the optimized efficiency mode based on mission data obtained from a mesh network of vehicles.

19. The method of claim 18,
wherein the acoustic signature control mode includes estimating the acoustic signature of the vehicle based on estimated noise output of a fan, a pump, and the fuel cell, and adjusting operation of the fan, the pump, and the fuel cell to drive the acoustic signature towards the target acoustic signature level;
wherein the thermal signature control mode includes obtaining thermal signature data of the thermal signature of the vehicle from a first temperature sensor and ambient temperature data from a second temperature sensor, and operating the fan, the pump, and the fuel cell to drive the thermal signature of the vehicle towards the target thermal signature level;
wherein the acoustic and thermal signature control mode includes obtaining thermal signature data of the thermal signature of the vehicle from a temperature sensor and acoustic signature data of the acoustic signature of the vehicle from an acoustic sensor, and operating the fan, the pump, and the fuel cell to maintain both the thermal signature of the vehicle at the target thermal signature level and the acoustic signature of the vehicle at the target acoustic signature level; and
wherein the optimized efficiency mode includes obtaining ambient temperature, humidity, windspeed, and light intensity data, and controlling the fuel cell and the fuel cell TMS based on the ambient temperature, humidity, windspeed, and light intensity data to optimize an energy efficiency of the fuel cell and the fuel cell TMS for current ambient conditions.

20. The method of claim 18, further comprising:
operating the fuel cell and the fuel cell TMS according to a decoy mode in which at least one of the acoustic signature or the thermal signature are increased to a decoy level.
